(19) United States
(12) Patent Application Publication
(10) Pub. No.: US 2026/0037859 A1
(43) Pub. Date: Feb. 5, 2026

(54) Hierarchical Embedding Tree for Efficiently Caching Large Contexts

(71) Applicant: DeepMind Technologies Limited, London (GB)

(72) Inventors: Florian Nils Hartmann, Zurich (CH); Duc-Hieu Tran, Zurich (CH)

(21) Appl. No.: 18/790,725

(22) Filed: Jul. 31, 2024

(51) Int. Cl. G06N 20/00

(52) U.S. Cl. CPC G06N 20/00

(57) ABSTRACT

An example method includes obtaining a hierarchical embedding tree that embeds context data in a plurality of embedded representations respectively associated with a plurality of nodes. In the example method, each respective embedded representation associated with each respective terminal node of a plurality of terminal nodes of the plurality of nodes is generated based on a respective chunk of the context data. In the example method, each respective embedded representation associated with each respective non-terminal node of a plurality of non-terminal nodes of the plurality of nodes is generated based on the embedded representations associated with two or more of the plurality of nodes that are child nodes of the respective non-terminal node. The example method includes generating, based on an update to a chunk of the context data, updated embedded representations respectively for a plurality of nodes that are intersected by a path from a terminal node associated with the updated chunk to an ancestor node for the terminal node. The example method includes updating the hierarchical embedding tree using the updated embedded representations. The example method includes caching the updated hierarchical embedding tree for providing inputs to a machine-learned decoder model to generate responses to queries based on the updated context data.

### BACKGROUND

A computer can receive inputs. The computer can execute instructions to process the inputs to generate outputs using a parameterized model. The computer can obtain feedback on its performance in generating the outputs with the model. The computer can generate feedback by evaluating its performance. The computer can receive feedback from an external source. The computer can update parameters of the model based on the feedback to improve its performance. In this manner, the computer can iteratively “learn” to generate the desired outputs. The resulting model is often referred to as a machine-learned model.

### SUMMARY

Aspects and advantages of embodiments of the present disclosure will be set forth in part in the following description, or can be learned from the description, or can be learned through practice of the embodiments.

In an aspect, the present disclosure provides a first example computer-implemented method. In some implementations, the first example computer-implemented method includes obtaining a hierarchical embedding tree that embeds context data in a plurality of embedded representations respectively associated with a plurality of nodes. In some implementations of the example computer-implemented method, each respective embedded representation associated with each respective terminal node of a plurality of terminal nodes of the plurality of nodes is generated based on a respective chunk of the context data. In some implementations of the first example computer-implemented method, each respective embedded representation associated with each respective non-terminal node of a plurality of non-terminal nodes of the plurality of nodes is generated based on the embedded representations associated with two or more of the plurality of nodes that are child nodes of the respective non-terminal node. In some implementations, the first example computer-implemented method includes generating, based on an update to a chunk of the context data, updated embedded representations respectively for a plurality of nodes that are intersected by a path from a terminal node associated with the updated chunk to an ancestor node for the terminal node. In some implementations, the first example computer-implemented method includes updating the hierarchical embedding tree using the updated embedded representations. In some implementations, the first example computer-implemented method includes caching the updated hierarchical embedding tree for providing inputs to a machine-learned decoder model to generate responses to queries based on the updated context data.

In some implementations of the first example computer-implemented method, the hierarchical embedding tree corresponds to a rope data structure.

In some implementations, the first example computer-implemented method includes, for a respective query, accessing a cached hierarchical embedding tree, the cached hierarchical embedding tree comprising the hierarchical embedding tree or the updated hierarchical embedding tree. In some implementations, the first example computer-implemented method includes, for a respective query, constructing a respective input to the machine-learned decoder model based on one or more embedded representations obtained from the cached hierarchical embedding tree. In some implementations, the first example computer-implemented method includes, for a respective query, generating a respective response for the respective query by processing the respective input using the machine-learned decoder model.

In some implementations of the first example computer-implemented method, constructing the respective input includes combining the one or more embedded representations with one or more respective query embeddings to form the respective input.

In some implementations of the first example computer-implemented method, the one or more embedded representations comprise a root embedding associated with a root of the cached embedding tree.

In some implementations of the first example computer-implemented method, constructing the respective input includes obtaining a sequence of component embeddings based on the one or more embedded representations. In some implementations of the first example computer-implemented method, constructing the respective input includes combining the sequence of component embeddings with a sequence of respective query embeddings to form an input sequence for the respective input.

In some implementations of the first example computer-implemented method, a dimensionality of the component embeddings match a dimensionality of the respective query embeddings.

In some implementations of the first example computer-implemented method, the machine-learned decoder model is a sequence processing model that performs self-attention over the input sequence to generate an output sequence.

In some implementations of the first example computer-implemented method, the cached hierarchical embedding tree stores a respective sequence of component embeddings for each respective node. In some implementations of the first example computer-implemented method, the cached hierarchical embedding tree stores a respective sequence of component embeddings for the root node. In some implementations of the first example computer-implemented method, obtaining the sequence of component embeddings includes processing the one or more embedded representations using a machine-learned adapter model configured to receive one or more input embeddings.

In some implementations, the first example computer-implemented method includes obtaining the update to the chunk of the context data. In some implementations of the first example computer-implemented method, obtaining the update to the chunk of the context data includes constructing a first input to the machine-learned decoder model based on one or more embedded representations obtained from the hierarchical embedding tree before the hierarchical embedding tree is updated. In some implementations of the first example computer-implemented method, obtaining the update to the chunk of the context data includes generating a first response for a first query by processing the first input using the machine-learned decoder model. In some implementations of the first example computer-implemented method, obtaining the update to the chunk of the context data includes updating the chunk with updated data that is based on the first response.

In some implementations of the first example computer-implemented method, the first query includes an instruction to edit a portion of the context data.

In some implementations, the first example computer-implemented method includes generating a first embedded representation for a first node of the hierarchical embedding tree using a first machine-learned encoder. In some implementations, the first example computer-implemented method includes generating a second embedded representation for a second node of the hierarchical embedding tree using a second machine-learned encoder.

In some implementations of the first example computer-implemented method, the first machine-learned encoder is different from the second machine-learned encoder.

In some implementations of the first example computer-implemented method, the first node corresponds to a chunk of the context data containing data of a first data modality, and wherein the first machine-learned encoder is configured to process the first data modality. In some implementations of the first example computer-implemented method, the second node corresponds to a chunk of the context data containing data of a second data modality, and wherein the second machine-learned encoder is configured to process the second data modality.

In some implementations of the first example computer-implemented method, the first node is the terminal node associated with the updated chunk, and wherein the first embedded representation has a first precision. In some implementations of the first example computer-implemented method, the second node is the ancestor node, and wherein the second embedded representation has a second precision greater than the first precision.

In some implementations of the first example computer-implemented method, the second precision being greater than the first precision includes a dimensionality of the second embedded representation is higher than a dimensionality of the first embedded representation. In some implementations of the first example computer-implemented method, the second precision being greater than the first precision includes a bit depth used for the second embedding is higher than a bit depth used for the first embedding.

In some implementations of the first example computer-implemented method, updating the hierarchical embedding tree using the updated embedded representations includes inserting, in the hierarchical embedding tree, a non-destructive update comprising the updated embedded representations and versioning data associated with the updated embedded representations. In some implementations of the first example computer-implemented method, the hierarchical embedding tree is configured to facilitate retrieval of a cached embedded representation based on versioning data associated with the cached embedded representation.

In some implementations, the first example computer-implemented method includes accessing a context data tree generated by a context data processing application, wherein the context data tree includes the plurality of nodes, and wherein the cached hierarchical embedding tree inherits the plurality of nodes from the context data tree.

In an aspect, the present disclosure provides a second example computer-implemented method. In some implementations, the second example computer-implemented method includes generating, using a first encoder of the one or more machine-learned encoders, a first terminal embedded representation of a first chunk of training context data. In some implementations, the second example computer-implemented method includes generating, using a second encoder of the one or more machine-learned encoders, a second terminal embedded representation of a second chunk of training context data. In some implementations, the second example computer-implemented method includes generating, using a third encoder of the one or more machine-learned encoders, a non-terminal embedded representation that represents the first terminal embedded representation and the second terminal embedded representation. In some implementations, the second example computer-implemented method includes constructing a training input based on the non-terminal embedded representation. In some implementations, the second example computer-implemented method includes generating a training output using a machine-learned decoder to process the training input. In some implementations, the second example computer-implemented method includes updating at least one of the first encoder, second encoder, or third encoder based on an evaluation of the training output.

In an aspect, the present disclosure provides a third example computer-implemented method. In some implementations, the third example computer-implemented method comprises generating, based on an update to a chunk of context data, updated embedded representations respectively for a plurality of nodes of a cached hierarchical embedding tree that are intersected by a path from a terminal node associated with the updated chunk to an ancestor node for the terminal node. In some implementations of the third example computer-implemented method, the cached hierarchical embedding tree embeds context data in a plurality of embedded representations respectively associated with a plurality of nodes. In some implementations of the third example computer-implemented method, each respective embedded representation associated with each respective terminal node of the cached hierarchical embedding tree is generated based on a respective chunk of the context data. In some implementations of the third example computer-implemented method, each respective embedded representation associated with each respective non-terminal node of the cached hierarchical embedding tree is generated based on the embedded representations associated with two or more child nodes of the respective non-terminal node;

In some implementations, the third example computer-implemented method comprises updating the cached hierarchical embedding tree using the updated embedded representations; and

In some implementations, the third example computer-implemented method comprises providing an input based on the cached hierarchical embedding tree to a machine-learned decoder model to generate a response to a query associated with the updated context data.

In one example aspect, the present disclosure provides example non-transitory computer readable media storing instructions that are executable by one or more processors to cause a computing system to perform one or more operations of any one or more implementations of the first example computer-implemented method or the second example computer-implemented method or the third example computer-implemented method.

In one example aspect, the present disclosure provides a first example computing system comprising one or more processors and the example non-transitory computer readable media.

In one example aspect, the present disclosure provides a second example computing system. In some implementations, the example computing system includes one or more processors. In some implementations, the example computing system includes one or more non-transitory computer-readable media storing a cached hierarchical embedding tree that embeds context data in a plurality of embedded representations respectively associated with a plurality of nodes. In some implementations of the example computing system, each respective embedded representation associated with each respective terminal node of the cached hierarchical embedding tree is generated based on a respective chunk of the context data. In some implementations of the example computing system, each respective embedded representation associated with each respective non-terminal node of the cached hierarchical embedding tree is generated based on the embedded representations associated with two or more child nodes of the respective non-terminal node. In some implementations, the example computing system includes one or more non-transitory computer-readable media storing instructions that are executable by the one or more processors to cause the computing system to perform operations. In some implementations of the example computing system, the operations comprise generating, based on an update to a chunk of the context data, updated embedded representations respectively for a plurality of nodes of the cached hierarchical embedding tree that are intersected by a path from a terminal node associated with the updated chunk to an ancestor node for the terminal node. In some implementations of the example computing system, the operations comprise updating the cached hierarchical embedding tree using the updated embedded representations. In some implementations of the example computing system, the operations comprise providing an input based on the cached hierarchical embedding tree to a machine-learned decoder model to generate a response to a query associated with the updated context data.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to describe the related principles.

### BRIEF DESCRIPTION OF THE DRAWINGS

Detailed discussion of embodiments directed to one of ordinary skill in the art is set forth in the specification, which makes reference to the appended figures.

FIG. 1 is a block diagram of aspects of an example system for using a context graph according to example aspects of the present disclosure for executing inference using one or more machine-learned model(s).

FIG. 2 is a block diagram of aspects of an example system for using a context graph according to example aspects of the present disclosure for executing inference using one or more machine-learned model(s).

FIG. 3 is a block diagram of aspects of an example system for using a context graph according to example aspects of the present disclosure for executing inference using one or more machine-learned model(s).

FIG. 4 is a block diagram of aspects of example system for using a context graph according to example aspects of the present disclosure for executing inference using one or more machine-learned model(s).

FIG. 5 is a block diagram of aspects of example system for using a context graph according to example aspects of the present disclosure for executing inference using one or more machine-learned model(s).

FIG. 6 is a block diagram of aspects of example system for using a context graph according to example aspects of the present disclosure for executing inference using one or more machine-learned model(s).

FIG. 7 is a block diagram of aspects of example system for using a context graph according to example aspects of the present disclosure for executing inference using one or more machine-learned model(s).

FIG. 8 is a block diagram of aspects of example system for using a context graph according to example aspects of the present disclosure for executing inference using one or more machine-learned model(s).

FIG. 9 is a block diagram of aspects of example system for using a context graph according to example aspects of the present disclosure for executing inference using one or more machine-learned model(s).

FIG. 10 is a block diagram of aspects of example system for using a context graph according to example aspects of the present disclosure for executing inference using one or more machine-learned model(s).

FIG. 11 is a block diagram of aspects of example system for using a context graph according to example aspects of the present disclosure for executing inference using one or more machine-learned model(s).

FIG. 12 is a block diagram of aspects of example system for using a context graph according to example aspects of the present disclosure for executing inference using one or more machine-learned model(s).

FIG. 13 is a block diagram of aspects of example system for training one or more encoders to obtain a context graph according to example aspects of the present disclosure for executing inference using one or more machine-learned model(s).

FIGS. 14A, 14B, and 14C are block diagrams of aspects of example system for training one or more encoders to obtain a context graph according to example aspects of the present disclosure for executing inference using one or more machine-learned model(s).

FIG. 15 is a flowchart of an example method for training one or more machine-learned models according to aspects of the present disclosure.

FIG. 16 is a block diagram of an example processing flow for using machine-learned model(s) to process input(s) to generate output(s) according to example implementations of aspects of the present disclosure.

FIG. 17 is a block diagram of an example sequence processing model according to example implementations of aspects of the present disclosure.

FIG. 18 is a block diagram of an example technique for populating an example input sequence for processing by a sequence processing model according to example implementations of aspects of the present disclosure.

FIG. 19 is a block diagram of an example model development platform according to example implementations of aspects of the present disclosure.

FIG. 20 is a block diagram of an example training workflow for training a machine-learned model according to example implementations of aspects of the present disclosure.

FIG. 21 is a block diagram of an inference system for operating one or more machine-learned model(s) to perform inference according to example implementations of aspects of the present disclosure.

FIG. 22 is a block diagram of an example networked computing system according to example implementations of aspects of the present disclosure.

FIG. 23 is a block diagram of an example computing device according to example implementations of aspects of the present disclosure.

FIG. 24 is a block diagram of an example computing device according to example implementations of aspects of the present disclosure.

FIG. 25 is a flowchart of an example method for using an example context graph according to aspects of the present disclosure.

FIG. 26 is a flowchart of an example method for using an example context graph according to aspects of the present disclosure.

FIG. 27 is a flowchart of an example method for training one or more machine-learned models for generating an example context graph according to aspects of the present disclosure.

Reference numerals that are repeated across plural figures are intended to identify the same features in various implementations.

### DETAILED DESCRIPTION

Example implementations of the present disclosure provide techniques and systems for efficiently caching large amounts of context for input to a machine-learned model system to perform queries based on the context. An example system can process large amounts of context to compute latent values that are used within the system to generate a response. Subsequent queries may reference the same or similar context. Persisting latent values in a cache can help avoid computing the latent values repeatedly for the same or similar context. However, these values can become stale if based on context data that has since been updated. A context graph (e.g., a hierarchical embedding tree) according to aspects of the present disclosure can effectively factorize the computation of latent values over individual chunks of context. In this manner, the cache can be updated after an update to an arbitrary chunk of context with only a partial graph rebuild over the affected portions of the graph. The computational cost of this partial rebuild can be less than a full rebuild and can be invariant to a position of the arbitrary chunk within the context.

Traditional techniques for processing context include, for instance, computing key-value tensors for performing attention over an input sequence in a transformer layer and storing the tensors in a KV cache. The tensors can contain attention values corresponding to individual elements of the input sequence (e.g., directly computed from tokens of context data). In an example of causal language modeling, each element in the sequence is computed based on all preceding elements in the sequence. As such, updating the cache can involve recomputing all attention values for elements at and subsequent to an update position. For updates in the middle or beginning of long contexts, this can be an expensive computation.

Advantageously, an example context graph according to the present disclosure herein can reduce a computational cost of updates to context data. Latent embeddings of context data can be constructed using a hierarchical tree. A first layer of embedded representations can be generated directly from the input context data (e.g., using a first encoder). These representations can correspond to terminal or leaf nodes in the tree. The tree can be built leaf-to-root by progressively computing embedded representations of each non-terminal node based on the respective embedded representations of its child nodes. A root embedded representation associated with the root node of the tree can be used to construct an input to a decoder model for generating a query response.

Using this structure, for example, updating the root embedded representation after an update to an arbitrary chunk of context data can involve identifying a terminal node associated with the updated chunk. Advantageously, in some instances, embedded representations for subtrees that do not contain the affected terminal node can be re-used in updating the root embedded representation. For example, at least one child node to the root, which might represent a subtree containing half of the embedding tree, could be unaffected by the update and thus its embedding may not be stale. As such, the top-level embedding of that subtree can be used again to represent its corresponding portion of the context data in the re-computation of the root embedded representation (e.g., without updating any descendant embeddings). For instance, after an update, latent values can be re-computed for all ancestor nodes for each affected terminal node using the cached embeddings for all other nodes.

Advantageously, cache updates can involve a bounded number of updates (e.g., bounded by a height of the context graph) and can be independent of a position of the chunk in a sequence order. This can be particularly useful for long contexts that are subject to change. For example, an entire manuscript can be provided to a machine-learned model system as context for performing editing operations. A decoder model can generate edited content (e.g., text) that can be used to update portions of the manuscript. An example caching framework provided herein can be used to efficiently update cached latent values to represent the manuscript as edited, ready for subsequent queries.

Similarly, dialog-based workflows provide a useful mechanism for engaging with machine-learned models and systems to perform content processing tasks (e.g., text or image generation, question answering, etc.) or agent-based workflows (e.g., controlling external systems by generating API calls or other executable instructions, etc.). Such interfaces can leverage transcripts of messages between components of the system (e.g., “user” messages received via a user interface; “function” messages received from internal or external function calls; “assistant” messages received from a machine-learned model responsive to the dialog, etc.).

A machine-learned model can process a current state of the transcript to predict content for a next state of the transcript. These transcripts can be lengthy, so latent values computed for the transcript can be cached to decrease a computational cost of performing inference for each subsequent query in the transcript. Traditional caching schemes can break down if messages early in the transcript are updated, triggering a full re-computation of latents for all subsequent messages.

Advantageously, example context graphs according to the present disclosure can facilitate efficient updating of the cached latent values for individual messages or portions of messages, independent of message order. For example, a long transcript may begin with insertion into a message of some subject context (e.g., a description of a task to perform) followed by one or multiple messages that step through specific operations performed (or to perform) in service of the task. A top-level root embedding representing the full transcript can be efficiently recomputed for new tasks with only a partial rebuild of the graph, re-using previously computed latent embeddings if available and current.

Example implementations of the present disclosure can provide a number of technical effects and benefits. An example technical effect of example implementations of the present disclosure is the potential reduction in the computational cost associated with updating cached data used in machine-learned model systems. Improved efficiency can be achieved by updating only the embedded representations along the path from the affected terminal node to the root, rather than recomputing the entire cache. Unaffected parts of the tree can be carried forward without repeating their previous computations, decreasing computational cost and latency. This approach can be particularly beneficial for systems handling large volumes of data where frequent partial updates are common, such as in real-time document processing, analyzing dynamic data streams to monitor other systems or processes, template-based workflows, etc.

An example technical effect of example implementations of the present disclosure is improved latency of cache updates. For example, in interactive applications, where user inputs can frequently alter the context (e.g., dialog-based assistant systems, content editing, etc.), a context graph can facilitate rapid updates to the cache. Rather than recomputing the entire cache, only the affected branches of the graph-those that correspond directly to or obtain characteristics from the changed input-might need updating. This can result in a more responsive user interface as the system can more quickly begin processing new inputs after spending less time updating the cache. Similarly, in streaming applications such as real-time sensor data analysis, where various different parts of input context changes as different sensor data streams in, the hierarchical structure of the cache as described in the present disclosure can facilitate higher responsiveness to new sensor data updates.

An example technical effect of example implementations of the present disclosure is improved memory allocation compared to a contiguous buffer. In some traditional systems, large contiguous memory buffers can be inefficient, especially when dealing with large data sets where only portions of the data may be needed at any given time. This inefficiency can lead to higher memory usage and increased computational overhead due to the need to manage and traverse large contiguous buffers. Example implementations of the present disclosure, however, can use a context graph structure that allows for more granular control over memory allocation. By embedding context data in a hierarchical structure, memory can be allocated adaptively for each node. For instance, each node in the hierarchical tree may correspond to different embeddings which can be independently cached and retrieved, potentially using different memory locations, devices, or device types. This granular control can help reduce the overall memory footprint compared to a system that must allocate memory for a large, contiguous block of data. Furthermore, different memory types or locations can be allocated based on attributes of the nodes. For instance, certain nodes' embeddings can be stored in faster memory or in an otherwise more accessible location based on an expected use of those embeddings for re-building the tree. For example, an embedding for a node that is not expected to change can be cached in faster memory if its sibling nodes are expected to change often.

An example technical effect of example implementations of the present disclosure is In an example, a context graph can be distributed across multiple devices. For instance, an application that is distributed to multiple devices can use an on-device context graph. Updates to the context graph can be pushed to the devices from a server. Advantageously, updates to a context graph can be partial: the update package can include new embeddings for only the updated nodes. This can result in smaller updates communicated to the multiple devices, decreasing network bandwidth consumption.

An example technical effect of example implementations of the present disclosure is increased energy efficiency in performing operations using machine-learned models, thereby improving the functioning of computers implementing such models. For instance, example implementations can provide for more energy-efficient runtime execution or inference by reducing a cost of executing inference using long contexts. In some scenarios, increased energy efficiency can provide for less energy to be used to perform a given task (e.g., less energy expended to maintain the cached context in memory, less energy expended to perform calculations with the cached context, etc.). In some scenarios, increased energy efficiency can provide for more task(s) to be completed for a given energy budget (e.g., a larger quantity of tasks, more complex tasks, the same task but with more accuracy or precision, etc.).

In another example aspect, example implementations can provide for more energy-efficient training operations or model updates. For instance, a training iteration can include a forward pass that benefits from improved caching according to aspects of the present disclosure. In some scenarios, increased energy efficiency can provide for less energy to be used to perform a given number of update iterations (e.g., less energy expended to maintain the model in memory, less energy expended to perform calculations within the model, such as computing gradients, backpropagating a loss, etc.). In some scenarios, increased energy efficiency can provide for more update iterations to be completed for a given energy budget (e.g., a larger quantity of iterations, etc.). In some scenarios, greater expressivity afforded by model architectures and training techniques of the present disclosure (e.g., by facilitating memory-efficient representation of long contexts) can provide for a given level of functionality to be obtained in fewer training iterations, thereby expending a smaller energy budget. In some scenarios, greater expressivity afforded by model architectures and training techniques of the present disclosure can provide for an extended level of functionality to be obtained in a given number of training iterations, thereby more efficiently using a given energy budget.

In this manner, for instance, the improved energy efficiency of example implementations of the present disclosure can reduce an amount of pollution or other waste associated with implementing machine-learned models and systems, thereby advancing the field of machine-learning and artificial intelligence as a whole. The amount of pollution can be reduced in toto (e.g., an absolute magnitude thereof) or on a normalized basis (e.g., energy per task, per model size, etc.). For example, an amount of CO2 released (e.g., by a power source) in association with training and execution of machine-learned models can be reduced by implementing more energy-efficient training or inference operations. An amount of heat pollution in an environment (e.g., by the processors/storage locations) can be reduced by implementing more energy-efficient training or inference operations.

Example implementations of the present disclosure are described in more detail herein with respect to the enclosed figures.

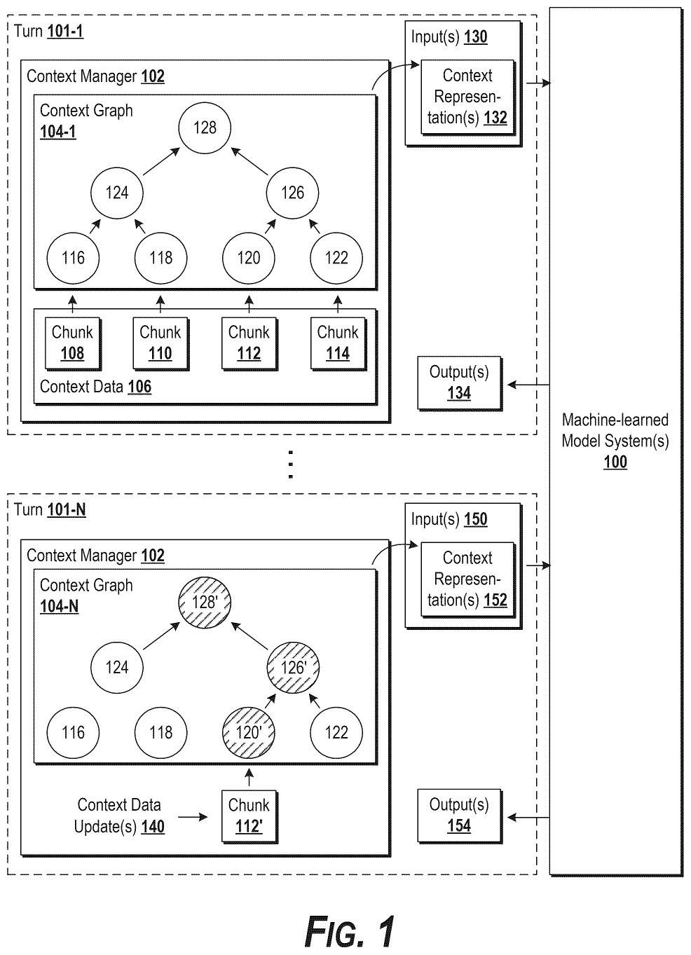

FIG. 1 is a block diagram of an example system for using a context graph according to example aspects of the present disclosure for executing inference using one or more machine-learned model(s). In an example, a context graph can form a tree structure of encoded representations or embeddings. The tree structure can represent a hierarchical data structure that builds layer upon layer to obtain encoded representations of context covered by preceding layers. For example, a context graph can be a hierarchical embedding tree.

Machine-learned model system(s) 100 can provide access to and execution of one or more machine-learned model(s) based on provided input data. Interactions with machine-learned model system(s) 100 can proceed over one or more iterations or turns, e.g., turn 101-1, . . . , turn 101-N. Each turn can include provide one or more inputs and receiving one or more outputs.

To facilitate turn 101-1, context manager 102 can construct a context graph 104-1 based on context data 106. Context data 106 can include data chunks 108, 110, 112, 114 that contain or represent portions of context data 106.

Context graph 104-1 can contain terminal nodes that respectively correspond to the chunks. For instance, at terminal or leaf node 116, context graph 104-1 can store an encoded representation (e.g., embedding) of chunk 108. At terminal or leaf node 118, context graph 104-1 can store an encoded representation (e.g., embedding) of chunk 110. At terminal or leaf node 120, context graph 104-1 can store an encoded representation (e.g., embedding) of chunk 112. At terminal or leaf node 122, context graph 104-1 can store an encoded representation (e.g., embedding) of chunk 114.

Context graph 104-1 can contain non-terminal nodes associated with an encoded representation computed based on descendent nodes of the non-terminal nodes. Non-terminal nodes can be nodes that have at least one child node. For instance, an encoded representation stored in association with node 124 can be computed based on encoded representations associated with the child nodes of node 124, nodes 116 and 118. An encoded representation stored in association with node 126 can be computed based on encoded representations associated with the child nodes of node 126, nodes 120 and 122. An encoded representation stored in association with root node 128 can be computed based on encoded representations associated with the child nodes of root node 128, nodes 124 and 126.

Input(s) 130 to machine-learned model system(s) 100 can include context representation(s) 132 obtained from context manager 102 using context graph 104-1. Context representation(s) 132 can represent all or part of context data 106. Input(s) 130 can include other input values, such as query values associated with a query over context data 106.

Outputs 134 can include or be based on using machine-learned model system(s) 100 to perform inference on input(s) 130.

All or part of context graph 104-1 can be cached to reduce a computational cost of subsequent turns. For example, in a subsequent turn at least a portion of context graph 104-1 can be retrieved from a cache for executing inference over the same context. Advantageously, the cached values can be updated responsive to updates to the context data without requiring a full graph rebuild.

Context data update(s) 140 can include any change to part of context data 106 that was encoded into context graph 104-1, such as an addition, deletion, substitution, or other alteration. In an example, chunk 112 can be changed to form a modified chunk 112′.

To facilitate queries based on the updated context in turn 101-N, context graph 104-1 can be partially rebuilt to form context graph 104-N using both new encodings and cached encodings. For instance, at updated terminal or leaf node 120′, context graph 104-N can store an encoded representation of updated chunk 112′. An encoded representation stored in association with updated node 126′ can be computed based on encoded representations associated with the child nodes of node 126, updated node 120′ and node 122. The encoded representation for node 122 can be retrieved from cache, as the underlying context represented by node 122 has not changed. An encoded representation stored in association with updated root node 128′ can be computed based on encoded representations associated with the child nodes of root node 128, node 124 and updated node 126′. The encoded representation for node 124 can be retrieved from cache, as the underlying context represented by node 124 has not changed.

Input(s) 150 to machine-learned model system(s) 100 can include context representation(s) 152 obtained from context manager 102 using context graph 104-N. Context representation(s) 152 can represent all or part of context data 106 and reflect the updates applied by context data update(s) 140. Input(s) 150 can include other input values, such as query values associated with a query over context data 106. Outputs 154 can include or be based on using machine-learned model system(s) 100 to perform inference on input(s) 150.

Machine-learned model system(s) 100 can provide an interface configured to facilitate executing one or more machine-learned models. Machine-learned model system(s) 100 can include a model host system that hosts and executes a machine-learned model (e.g., an on-device model). Machine-learned model system(s) 100 can include an application programming interface (API) or software development kit (SDK) that controls or instructs one or more model host system(s) remote from a computing device executing the API or SDK (e.g., cloud-hosted models).

Machine-learned model system(s) 100 can be or include one or multiple computing devices or systems. Machine-learned model system(s) 100 can locally execute a machine-learned model on a same device or system as executes context manager 102 or receives input(s) 130), such as a user device. Machine-learned model system(s) 100 can execute a machine-learned model on a remote server. Machine-learned model system(s) 100 can control model inference on the remote server using instructions (e.g., API calls) issued from a local device (e.g., a user device).

Machine-learned model system(s) 100 can include or facilitate interactions with machine-learned model(s) that provide predictions based on input context. A machine-learned model can generate a predicted output based on an input. The input can be or include context used to condition the predicted output. For instance, one or more portions of the output can be selected based on a value that, based on one or more portions of the input, is associated with an higher probability value than would be present if the one or more portions of the input were different.

Machine-learned model system(s) 100 can include a decoder model. A decoder model can include various different model architectures (e.g., “encoder” architectures, “decoder” architectures, etc.) that can decode information from the encoded representations in the context graph.

Turns (e.g., 101-1, . . . , 101-N) can represent groups of interactions or cycles between a user or system and machine-learned model system(s) 100. Each turn can involve an input to the system and an output from the system. Turns can be a unit of dialogue or interaction. Subsequent turns can build upon prior turns, allowing for incremental processing of information and refinement of responses based on the evolving context. Each turn can build upon the context established in previous turns. By caching the context graph, the system can efficiently retrieve and reuse relevant portions of the graph in future turns, thereby avoiding the full computational cost and latency associated with reconstructing or recalculating the entire context graph from scratch.

An example turn-based interaction modality is a dialogue. The dialogue can be between a user and an assistant system. The dialogue can be between a first system and an assistant system. The assistant system can engage other systems (e.g., tool systems) for assisting with servicing the queries submitted by a user or first system. Outputs from these other systems can be added to the dialogue or can be integrated directly into outputs returned from the assistant system.

Context manager 102 can include processing logic configured to facilitate the efficient use of context data 106 by machine-learned model system(s) 100. For instance, context manager 102 can manage a context cache in which one or more contextual embeddings are cached. Context manager 102 can engage, control, or otherwise instruct one or multiple computing devices to prepare and maintain a context cache. Context manager 102 can use one or more context graphs 104-1, . . . , 104-N to manage the context cache.

A context graph 104-1, . . . , 104-N can be a structured data object or data store that stores representations of context data in a hierarchical manner that facilitates partial rebuilding of the representation(s) to respond to changes in the underlying context data. A context graph can be implemented using a tree structure in which each respective subtree represents a respective portion of the context data. In this manner, for instance, a context cache can be updated responsive to updates to a respective portion of the context data by updating the respective subtree (e.g., only the respective subtree). This architecture can help reduce a cost of processing updated context data.

Context data 106 can include a variety of data in one or multiple datatypes. Context data 106 can include one or multiple modalities of data, such as text or other symbolic data, audio, imagery (e.g., still or video), etc. Context data 106 can be input by a user, obtained from one or more sensors of a device, retrieved from storage, received over a network, etc. At least a portion of context data 106 can be generated by machine-learned model system(s) 100 (e.g., over one or more turns).

Context data chunks (e.g., 108, 110, 112, 114) can represent discrete segments of context data 106. For instance, a chunking algorithm can be applied to segment context data 106 into chunks for processing.

In an example, chunks can be based on size. For instance, a chunk of data can be chunked together based on a chunk size limit. An example chunk size limit is a data size (e.g., in bytes) of the data in the chunk. An example chunk size limit is a sequence length for a sequence of tokens or embeddings used to represent the data in the chunk. An example chunk size limit is a word count for text. An example chunk size limit is a duration for selecting an interval of time-varying data (e.g., audio, video, data streams, etc.).

Context data chunks (e.g., 108, 110, 112, 114) can be chunked based on structures within context data 106. For instance, chapters of a book or other sections of a document can be inherited as chunks. Chunk boundaries can be obtained based on data objects present in context data 106. For instance, discrete data objects can be chunked separately from other data objects. For instance, a media file (e.g., image, audio, video, etc.) can be associated with its own chunk. Other media files (e.g., other images, audio, video, etc.) can be chunked separately. Other content can be chunked separately, such as one or more chunks for text or other content.

Context data chunks (e.g., 108, 110, 112, 114) can be chunked based on data modality. For instance, different modalities can be chunked together for processing. For instance, encoded representations can be generated using an embedding model, and each modality can use a different embedding model. Chunking context data 106 based on modality can provide natural correspondence to input streams for respective embedding models.

In an example, context data chunks are chunked into “runs” of data. For instance, a context graph can be a rope data structure that groups portions of context data along with a position of the context data (e.g., a starting position or index).

Each context data chunk can be associated with metadata that describes or annotates the chunk. This metadata can include information such as the source of the chunk, timestamps, data type identifiers, or any other descriptive data that might be useful for processing or managing the chunk within the system.

In an example, in a text processing application, each chunk might represent a document, a chapter, a paragraph, or a section of text within a document. In an image processing context, chunks might represent different regions or segments of an image, each potentially focusing on different objects, areas, or features within the image. In applications processing audio or video data, chunks might represent different time segments of an audio or video file.

Nodes of the context graph (e.g., 116, . . . , 128) can correspond to data objects that store encoded representations of a subset of context data 106. The graph-based nature of the nodes can be explicit. For instance, nodes can be explicitly configured in a graphical arrangement (e.g., storing graph positions, storing references to adjoining nodes, a node data object with attributes pointing to child node data objects, etc.). The graph-based nature can be implicit in the generation of the node values without explicitly storing the structure thereof. For instance, node values can be stored in a flat list, such that the hierarchy is implicitly represented in the generation of the values rather than the storage mechanism itself.

In general, a node can store an encoded representation of a portion of context data 106 that is covered by a subtree of which that node is the local root. For terminal nodes, the subtree can be the node itself, a single leaf node. The leaf node can store an encoded representation of a portion of context data in a context chunk mapped to the leaf node. For non-terminal nodes, the subtree can include one or more child or descendant nodes. The non-terminal node can store an encoded representation of a portion of context data in one or more chunks that are respectively mapped to leaf nodes that are descendants of the non-terminal node.

An encoded representation stored in association with a node of the context graph can have various different forms. In general, an encoded representation can be a representation of underlying data that transforms some underlying data into a collection of latent values that represents information from or about the underlying data. An encoded representation can include an embedded representation of data, such as a vector representation in an embedding space. An encoded representation can include multiple embedded representations (e.g., a tensor containing multiple vectors). An encoded representation can be quantized (e.g., constructed using vector quantization, such as product quantization). An encoded representation can include a sequence of individual embeddings, such as a sequence of tokens that correspond to distinct embedded values (e.g., from a vocabulary or codebook). The sequence can be fixed length or variable. In this manner, for instance, chunk size can vary, and an expressive capacity of the encoded representation can adapt by adding to the sequence length while maintaining a dimensionality of the individual embeddings in the sequence. This can maintain compatibility with an input space of an encoder used to encode a parent embedding of the sequence.

Each node can store a different encoded representation. Different nodes can store different types of encoded representations. For instance, lower layers of the tree (e.g., toward the leaf nodes) can be embeddings having a different dimensionality as compared to embeddings of higher layers of the tree (e.g., toward the root). Different subtrees can use different encoded representation arrangements. For example, the encoded representation formats used by different leaf nodes can be different, while non-terminal nodes that respectively represent the different leaf nodes can use the same encoded representation format for combination by a parent node of the non-terminal nodes.

Input(s) 130, 150 can contain data for input to machine-learned model system(s) 100. Inputs can be composed of multiple elements that together provide context for generating an output prediction or other response from machine-learned model system(s) 100.

A component of input(s) 130, 150 can be based on one or more context representation(s) 132, 152. A context representation can be obtained from a context graph. A context representation can be selected to represent a desired scope of context data. For instance, a non-terminal node can represent information from or about the context data respectively represented by all its descendent nodes. In this manner, for instance, a root node of a context graph can represent all of context data 106. The encoded representation for the root node can be used as context representation 132, 152 to represent the whole of context data 106. Other encoded representations can be used as context representation 132, 152 in addition to or in lieu of an encoded representation from the root. For example, lower-level encoded representations can be used to represent specific portions of context data.

A component of input(s) 130, 150 can include query values. The query values can provide additional inputs for processing by machine-learned model system(s) 100. The query values can include instructions, questions, or other requests. The query values can be based on data from textual modalities, image-based, audio-based, or any other data modality. The query values can include embedded values or the raw inputs (e.g., to be further ingested by machine-learned model system(s) 100). Machine-learned model system 100 can process inputs 130, 150 to generate query embeddings (e.g., embeddings of the query values) for processing with the context embeddings.

Query values can vary widely depending on the application. For example, in a text editing application, query values might include commands or parameters specifying how a text represented by context representation 132, 152 should be modified. In a data analysis application, query values might involve parameters defining the scope, depth, or specific aspects of the analysis to be performed. In a video processing application, query values can include instructions to modify a particular scene or segment.

Output(s) (e.g., 134, 154) can represent the response generated by machine-learned model system(s) 100 after processing the input(s) (e.g., 130, 150) obtained based on the context graphs (e.g., 104-1, 104-N). Output(s) (e.g., 134, 154) can include textual responses generated by a text generation model within the machine-learned model system(s) 100. For instance, in response to a query regarding the contents of context data 106, an output might be a textual response to the query. Output(s) (e.g., 134, 154) can include graphical or multimedia content. For example, in applications involving image processing or enhancement, the output can be an enhanced or modified image that has been processed according to the parameters specified in the input(s). In video content editing or generation applications, the output can be a sequence of video frames that have been generated or modified in response to the context data and the query values included in the input(s). Output(s) (e.g., 134, 154) can include structured data formats such as JSON, XML, or CSV files that encapsulate information in a structured manner suitable for further computational processing or analysis by other systems. For instance, in data analytics applications, the output might be a structured dataset containing aggregated data points or statistical summaries calculated based on the context data processed by the model. The output might be an encapsulated API call for invoking an API to perform a task.

Context data update(s) 140 can include a change of a part of context data 106 or an addition to context data 106. For instance, context data update(s) 140 can include an insertion of new context data, removal of existing context data, or alteration of an aspect of the context data (e.g., content, arrangement, etc.).

Context data update(s) 140 can be based on output(s) 134. For instance, machine-learned model system(s) 100 can process a representation of all or part of context data 106 and generate updates to context data 106. Context data update(s) 140 can include an edit to be applied to an underlying data item or can contain a replacement copy of the data item with the edits applied.

Rebuilding the context graph to obtain updated context graph 104-N can leverage cached encoded representations for nodes in subtrees that are not affected by the update. For instance, cached encoded representations for node 122 can be used in conjunction with the new encoded representations for node 120′ to obtain a new encoded representation for node 126′. Similarly, cached encoded representations for node 124 can be used in conjunction with the new encoded representations for node 126′ to obtain a new encoded representation for node 128′. In this manner, for instance, the operations associated with generated the encoded representations that are retrieved from the cache can be spared in the subsequent rebuild. Rebuilding the context graph can include generating updated embedded representations respectively for a plurality of nodes that are intersected by a path from a terminal node associated with the updated chunk to an ancestor node for the terminal node (e.g., the root node).

All prior generated encodings can be cached. Caching can be selective based on an expected likelihood of recomputation. For instance, higher-level nodes are more likely to be recomputed, since they represent larger subtrees that cover a wider range of context data 106. As such, child encodings to such higher-level nodes can be prioritized in a cache (e.g., further descendant embeddings can be purged to free space in the cache). Caching can be selective based on an expected computational cost of recomputation. For instance, some encodings can be generated using more costly procedures than other encodings (e.g., larger, more computationally expensive encoding models; higher dimensionality encodings; etc.). More expensive encodings can be prioritized in a cache (e.g., lower-cost encodings can be purged to free space in the cache).

Context manager 102 can non-destructively update context graphs to maintain a history of changes that can be rolled back. For instance, nodes can store a version value, and different values for a node can be retrieved based on a desired version. For instance, updated values for 120′, 126′, and 128′ can be stored with an updated version number different from an original version number. An updated version number can also be associated with the other non-updated nodes to indicate that the stored value for those nodes is also compatible with the new version.

The architecture of context graphs 104-1, . . . , 104-N can be optimized for different implementations. For example, for a given set of context data, a chunk size can be inversely correlated to a height of the context tree. A height of the context tree can be correlated to a quantity of intermediate embeddings that respectively combine smaller subtrees from the preceding layers, such that taller context trees can involve a larger number of encoding operations (for generating the intermediate embeddings). In some instances, a quantity of component encodings can be compensated using a size of the component encodings. For instance, fewer, larger encodings (e.g., larger chunks) can be used. In some instances, more, smaller encodings (e.g., smaller chunks) can be used.

The architecture of context graphs 104-1, . . . , 104-N can be optimized for size and recall. In an example, larger, more expressive encodings can facilitate higher recall of the context data in machine-learned model system(s) 100. However, larger, more expressive encodings can be more expensive to generate and store. In an example, encodings used for higher-level nodes (e.g., nodes that represent a larger range of context data) can be more expressive (e.g., increased dimensionality of embeddings, higher quantity of embeddings, increased bit depth, larger codebook, etc.) than lower-level nodes (e.g., nodes that represent a smaller range of context data).

In an example, the architecture of the context graph can be inherited from an application that generates the context data. For instance, a text editing application can store text data in a rope data structure. The text editing application can use the rope data structure to efficiently index and edit large spans of text. The rope data structure architecture can be used to construct a context graph. For instance, the leaf nodes of the context graph can store embeddings that represent the leaf nodes of the rope data structure.

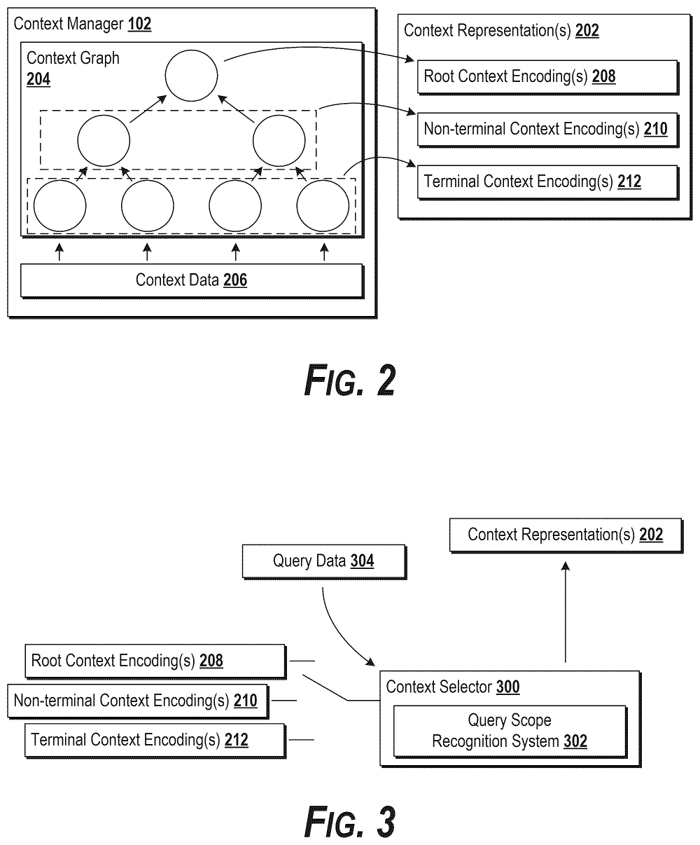

FIG. 2 is a block diagram of aspects of an example system for using a context graph according to example aspects of the present disclosure for executing inference using one or more machine-learned model(s). Context representations 202 can be obtained from a context graph 204. Context representations 202 can be representative of, the same as, or different from context representations 132, 152. Context graph 204 can be a context graph generated by context manager 102 using context data 206 (e.g., an initial context graph, such as context graph 104-1, or an updated context graph, such as context graph 104-N). Context data 206 can be representative of, the same as, or different from context data 104 or a set of updated context data (e.g., including an updated chunk 112′). In various implementations, context representation(s) 202 can contain any one or more encoding types selected from the following: root context encoding(s) 208, non-terminal context encoding(s) 210, or terminal context encoding(s) 212.

Root context encoding(s) 208 can include one or more encoded representations obtained from a root level of a context graph. Such encodings can provide an overall representation of the context data. In some cases, root context encoding(s) 208 exhibit data compression by representing context data 206 in fewer bytes.

Non-terminal context encoding(s) 210 can include one or more encoded representations obtained from an intermediate or non-terminal level of the context graph. Non-terminal context encoding(s) 210 can provide a representation of a portion of context data covered by the corresponding subtree. Multiple non-terminal context encoding(s) 210 can collectively provide coverage of all or part of the context data. Non-terminal context encoding(s) 210 can exhibit less data compression as compared to root context encoding(s) 208. For instance, a non-terminal context encoding 210 can proportionally use more bytes for a given portion of context data.

Terminal context encoding(s) 212 can include one or more encoded representations obtained from a terminal node of a context graph. Terminal context encoding(s) 212 can provide a representation of a specific portion of context data mapped to a terminal node (e.g., a specific chunk of context). Terminal context encoding(s) 212 can exhibit less data compression as compared to non-terminal context encoding(s) 210. For instance, a terminal context encoding 212 can proportionally use more bytes for a given portion of context data.

One or multiple encodings can be provided in context representation(s) 202. For instance, both higher-level encodings and lower-level encodings can be provided together. Alternatively, higher-level encodings can be used in lieu of lower-level encodings, and vice-versa, depending on a need of the system.

In general, a selection of encodings can be based on a desired recall and an acceptable computational cost. For example, a single root encoding that represents all of context data 206 may be relatively small (e.g., computationally cheaper to process with machine-learned model system(s) 100) as compared to a full set of non-terminal encodings that represent the same context data. However, the full set of non-terminal encodings may be more expressive (e.g., less compression), which may return some improvements in recall in some situations. For instance, based on an amount of resources available or other constraints on a computing system (e.g., latency constraints, power constraints, etc.), encodings can be selected for context representations 202.

To facilitate compatible interchange of encodings, machine-learned model system(s) 100 can be configured to ingest any one or all of root context encoding(s) 208, non-terminal context encoding(s) 210, or terminal context encoding(s) 212. For instance, machine-learned model system(s) 100 can be configured with a different decoder for each different input format required for each of root context encoding(s) 208, non-terminal context encoding(s) 210, or terminal context encoding(s) 212.

Any one or all of root context encoding(s) 208, non-terminal context encoding(s) 210, or terminal context encoding(s) 212 can be configured to use a common format, encoding, dimensionality, etc. In an example, root context encoding(s) 208, non-terminal context encoding(s) 210, or terminal context encoding(s) 212 share a common embedding space so that they may be processed using a common decoder.

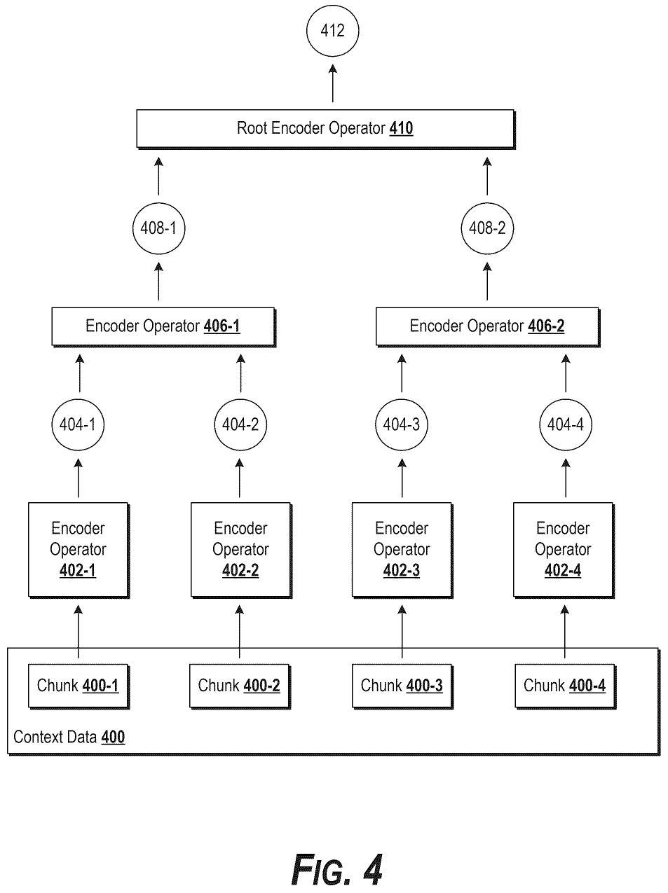

FIG. 3 is a block diagram of aspects of an example system for using a context graph according to example aspects of the present disclosure for executing inference using one or more machine-learned model(s). A context selector 300 can use a query scope recognition system 302 to process query data 304 to determine a scope of relevant context data for input to machine-learned model system(s) 100. Based on a determined scope, one or more or all of root context encoding(s) 208, non-terminal context encoding(s) 210, or terminal context encoding(s) 212 can be selected for inclusion in context representation(s) 202. In this manner, for instance, more focused encodings can be used if only a specific portion of context is required.

Context selector 300 can be a preprocessing layer that intercepts or otherwise monitors a current task or query relating to context data 206. Context selector 300 can access cached encodings from the context graph and retrieve the encodings that align with a query scope needed for processing a particular query with machine-learned model system(s) 100.

Query scope recognition system 302 can use one or more machine-learned model(s) (e.g., a model of machine-learned model system(s) 100) to process a query or other data indicating a scope of a task to be performed. For example, natural language queries can be processed using a natural language processing model (e.g., a sequence processing model, such as a transformer-based model) to output a prediction of what scope is needed for a particular query.

Query data 304 can be input data input for a query. Query data 304 can be system data associated with a query (e.g., a current system or application state, such as a scroll position, cursor position, etc.). Query data 304 can include a trace of prior queries. In an example, a chunking schema could be represented using a structured textual representation (e.g., JSON) and input to query scope recognition system 302 to predict a location of an encoding to be used to process a query.

Query data 304 can include a chunking schema. For example, a chunking schema can represent metadata associated with the context data and its subdivision into chunks.

In the absence of a high-confidence selection (e.g., a regressed confidence value; a logit value; etc.), context selector 300 can default to returning one or more encodings that represent all the context.

In an example, a query scope may be focused on a specific detail of a portion of a long context document. For example, a context document can be a book with many chapters. Each chapter can be chunked separately, so that a terminal context embedding is associated with each chapter. A query can include a question relating to a specific chapter. Query scope recognition system 302 can process the query and identify that the query relates to the specific chapter. As such, the query may be more effectively and efficiently processed in view of focused encoded representations that relate to that chapter rather than high-level, overall encodings that encode the entire book.

Using the information extracted from the query and available information on the chunking schema, context selector 300 can select an appropriate embedding to represent the scope of information needed to respond to the query. For instance, a chunking schema for the book example above could represent that each chunk represents a specific chapter.

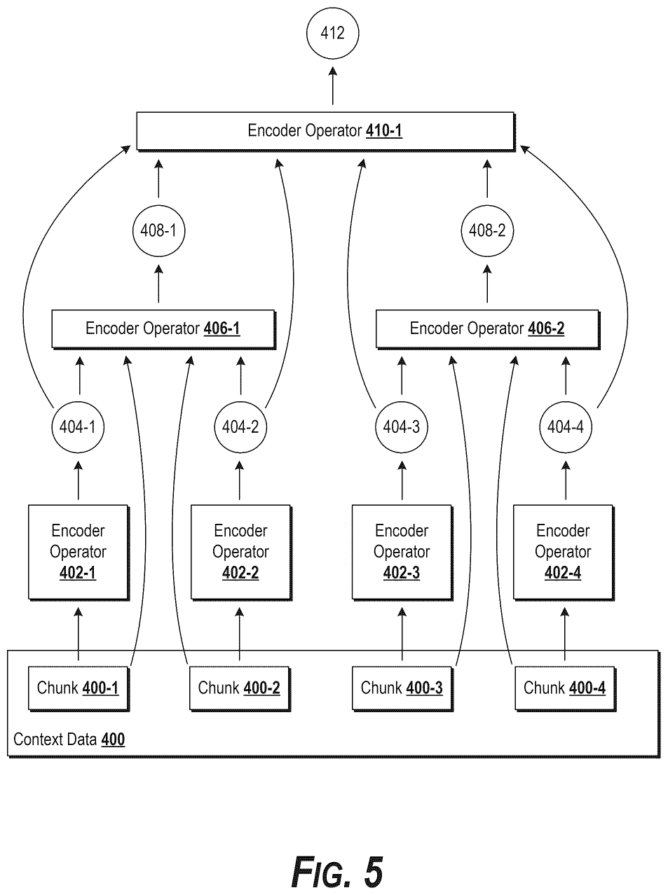

FIG. 4 is a block diagram of aspects of example system for using a context graph according to example aspects of the present disclosure for executing inference using one or more machine-learned model(s). Context data 400 can be chunked into chunks 400-1, 400-2, 400-3, 400-4, etc. Each chunk can be encoded into an encoded representation associated with a terminal node of a context graph. For instance, chunk 400-1 can be processed by encoder operator 402-1 to obtain an encoded representation 404-1. Chunk 400-2 can be processed by encoder operator 402-2 to obtain an encoded representation 404-2. Chunk 400-3 can be processed by encoder operator 402-3 to obtain an encoded representation 404-3. Chunk 400-4 can be processed by encoder operator 402-4 to obtain an encoded representation 404-4.

These generated encodings can correspond to terminal nodes of a context graph. Encodings associated with non-terminal nodes can be generated based on descendent nodes thereof. For example, encoder operator 406-1 can process at least encoded representations 404-1 and 404-2 to generate encoded representation 408-1. Encoder operator 406-2 can process at least encoded representations 404-3 and 404-4 to generate encoded representation 408-2. Encoder operator 410-1 can process at least encoded representations 408-1 and 408-2 to generate encoded representation 412.

Context data 400 can be representative of, the same as, or different from context data 106 or 206 or a set of updated context data (e.g., including an updated chunk 112′).

Chunks 400-1, 400-2, 400-3, 400-4 can be representative of, the same as, or different from chunks 108, 110, 112, 114, 112′.

An encoder operator can include a function call, API call, or other executable instruction set that initiates an encoding operation, performed by an encoder, on an input data item to output an encoded representation thereof. Multiple different encoder operators can use the same encoder with different input(s). Different encoder operators can use different encoders.

Terminal encoder operators 402-1, 402-2, 402-3, 402-4 can each use the same encoder, each use a different encoder, or contain at least two encoder operators that use different encoders. For instance, encoder operator 402-1 can be different from encoder operator 402-2 based on a difference between data in chunk 400-1 and data in chunk 400-2. For example, encoder operators can be selected based on a data modality of data in a given chunk.

Encoder operators that use different encoders can be configured to output encodings in a common encoding space. For instance, the outputs of encoder operator 402-1 and encoder operator 402-2 can be mapped to a common output space to facilitate encoder operator 406-1 to ingest the encodings. The outputs of encoder operator 402-1 and encoder operator 402-2 can be mapped to different output spaces (e.g., embedded representations having different dimensionalities), and encoder operator 406-1 can be configured with input layers configured to receive each respective embedded representation in each different output space.

A layer of non-terminal encoder operators (e.g., 406-1, 406-2) can each be the same, each be different, or contain at least two different encoder operators. A non-terminal encoder operator can be the same as or different from a terminal encoder operator.

Root encoder operator 410 can be the same as or different from a non-terminal encoder operator or a terminal encoder operator.

In general, encoder operators for lower levels of the tree (e.g., closer to the leaf nodes) can process lower-dimensional encodings, or lower numbers of encodings as compared to encoder operators for higher levels of the tree.

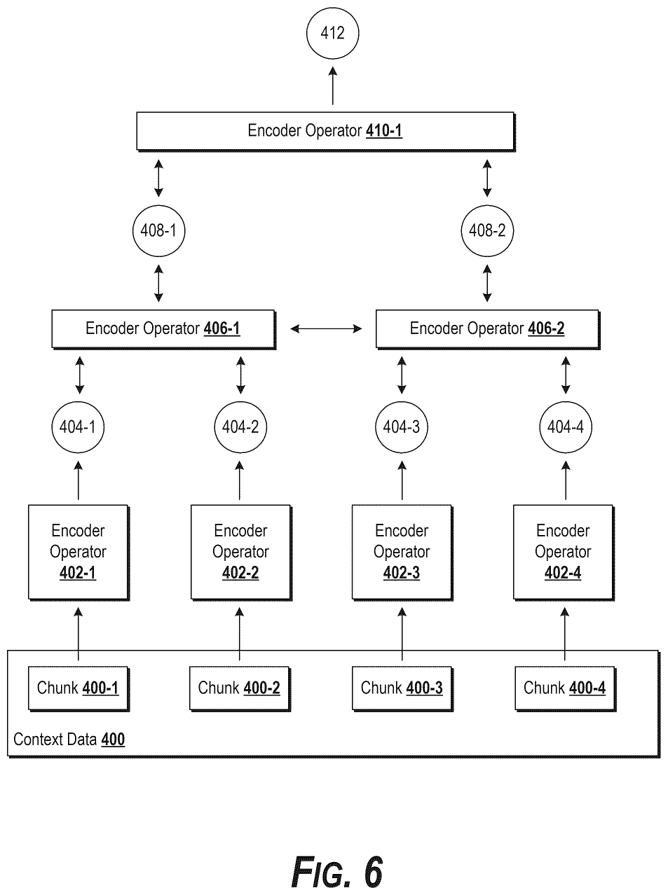

FIG. 5 is a block diagram of aspects of example system for using a context graph according to example aspects of the present disclosure for executing inference using one or more machine-learned model(s). In some implementations, data from one level of a context graph can skip a parent node and pass to a grandparent or higher ancestor node. One or more subgraphs (e.g., some of, all of) of the context graph can implement skip connections.

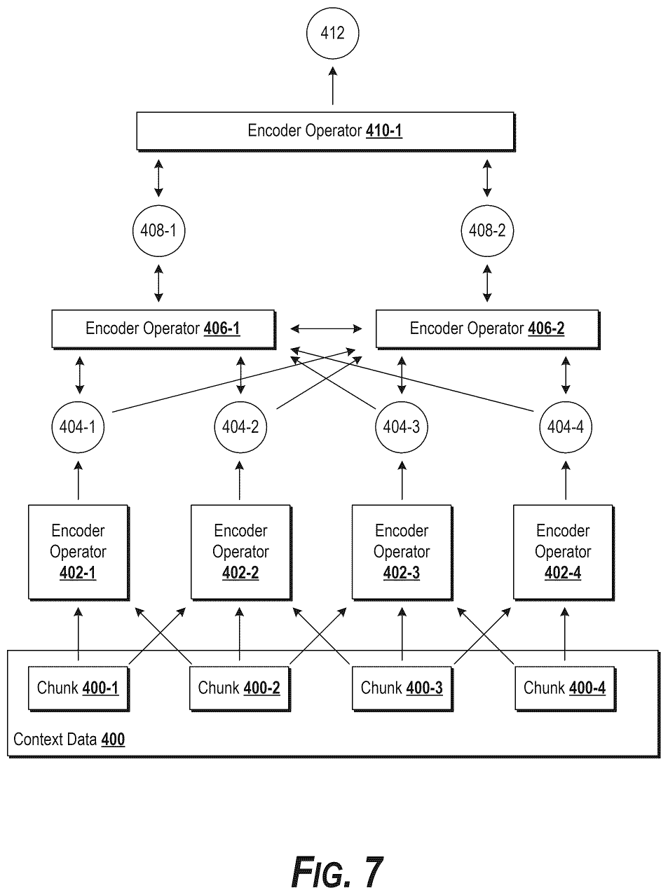

FIG. 6 is a block diagram of aspects of example system for using a context graph according to example aspects of the present disclosure for executing inference using one or more machine-learned model(s). In some implementations, data encoded by the respective operators can flow both up the graph (to the root) and down the graph (toward the leaf nodes). In this manner, information from a particular chunk of context can spread across the context graph to subgraphs outside a direct path from the chunk to the root. In an example, a context graph can be updated across one or more iterations of a message-passing algorithm (e.g., belief propagation). In each iteration, an encoder can compute an embedding value based on inputs from child nodes and ancestor nodes. Iterations can continue until a stopping criterion is reached (e.g., a count of iterations, a rate of change in the embedding values, etc.).

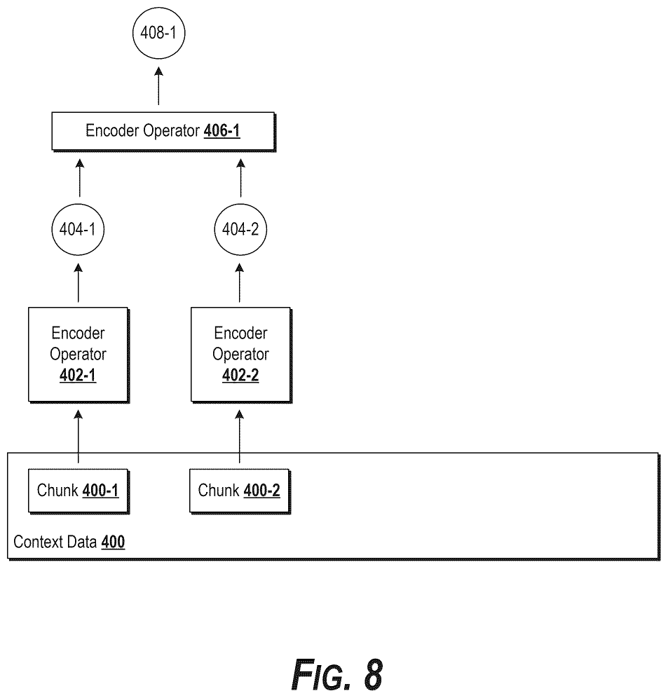

FIG. 7 is a block diagram of aspects of example system for using a context graph according to example aspects of the present disclosure for executing inference using one or more machine-learned model(s). Encoded representations can be computed in context by including, as inputs, neighboring values. For instance, computing an encoded representation 404-3 can be based not only on chunk 112 but also on chunks 114 and 110. Encoder operator 402-3 can ingest chunks 114 and 110 in combination with chunk 112. Encoder operator 402-3 can ingest each of chunks 110 and 114 in turn to generate individual encodings that can be combined with the encoding generated from chunk 112 individually. In an example, an influence of neighboring chunks 110 and 114 on encoded representation 404-3 can be discounted as compared to chunk 112. For instance, components attributable to chunks 110 and 114 can be weighted less than a component attributable to chunk 112 in a weighted combination.

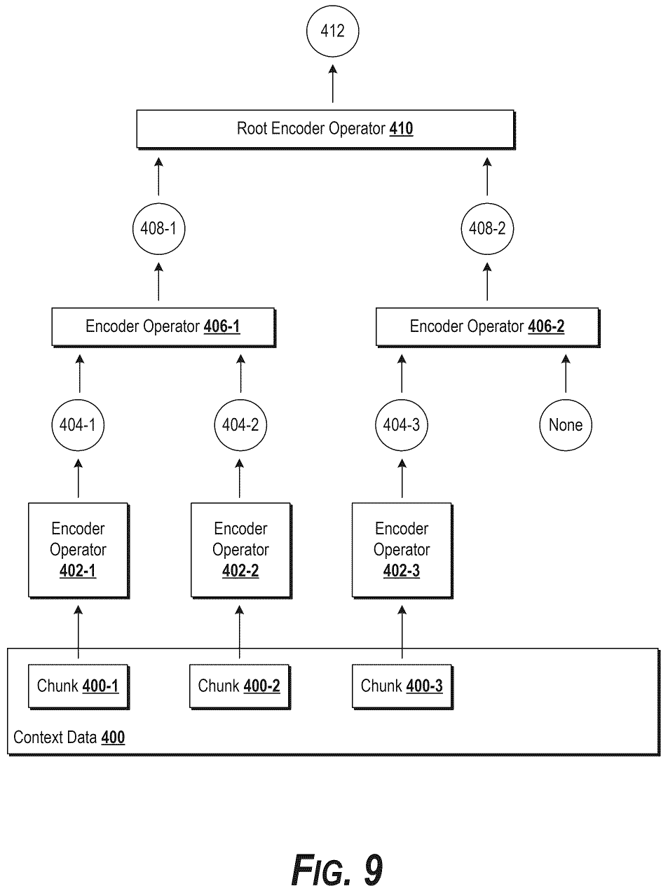

FIG. 8 is a block diagram of aspects of example system for using a context graph according to example aspects of the present disclosure for executing inference using one or more machine-learned model(s). In an example, a context graph can grow in size based on a size of context data 400. For instance, if context data 400 only includes chunks 400-1 and 400-2, then encoded representation 408-1 can be the root (e.g., without encoded representation 412 in the graph).

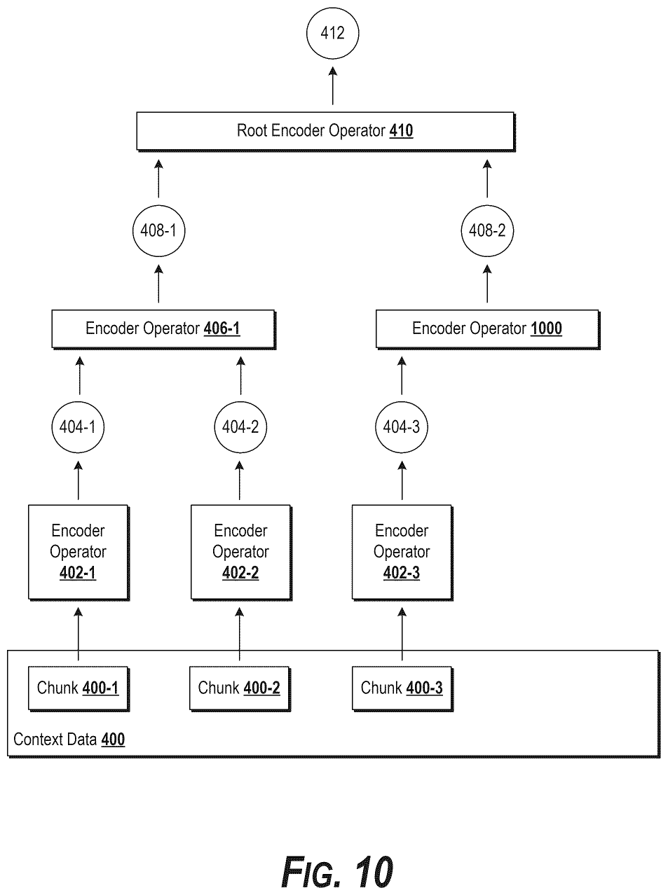

FIG. 9 is a block diagram of aspects of example system for using a context graph according to example aspects of the present disclosure for executing inference using one or more machine-learned model(s). As chunk 400-3 is added, a new level to the tree can be added that represents both the subtree under encoded representation 408-1 and a new subtree that extends to chunk 400-3. Encoder operator 406-2 can process the encoded representation of chunk 400-3 and, in the absence of further chunks, either process no other embeddings or an empty or blank embedding (e.g., all zeros).

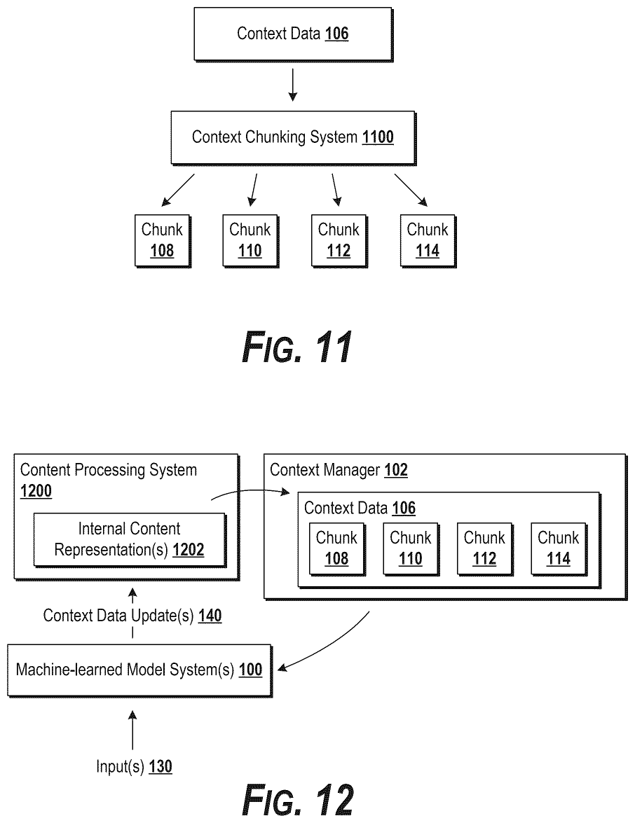

FIG. 10 is a block diagram of aspects of example system for using a context graph according to example aspects of the present disclosure for executing inference using one or more machine-learned model(s). Alternatively to the arrangement shown in FIG. 9, a singleton encoder operator 1000, configured to process only the one encoded representation, can be used to re-format/re-encode encoded representation 404-3 into encoded representation 408-2 for input to root encoder operator 410.

The growth of the context graph can proceed according to a defined framework of encoder operators. At each growth stage, encoded representations from the preceding graph can be used to generate the new, larger graph. In an example, a set of encoder operators is defined for a number of levels of a context graph, such that growth cannot proceed beyond the number of levels. In an example, a set of encoder operators is configured to be compatible across layers, such that growth can be unbounded.

In an example, after a certain amount of growth, context manager 102 can begin to prune the context graph to add new context without growing the context graph. Pruning the context graph can include deleting or deactivating certain subtrees in a version of the context graph and performing a rebuild of any affected portions. In an example, deleting a subtree and merging two subtrees can re-use at least some of the existing encoded representations in the respective subtrees.

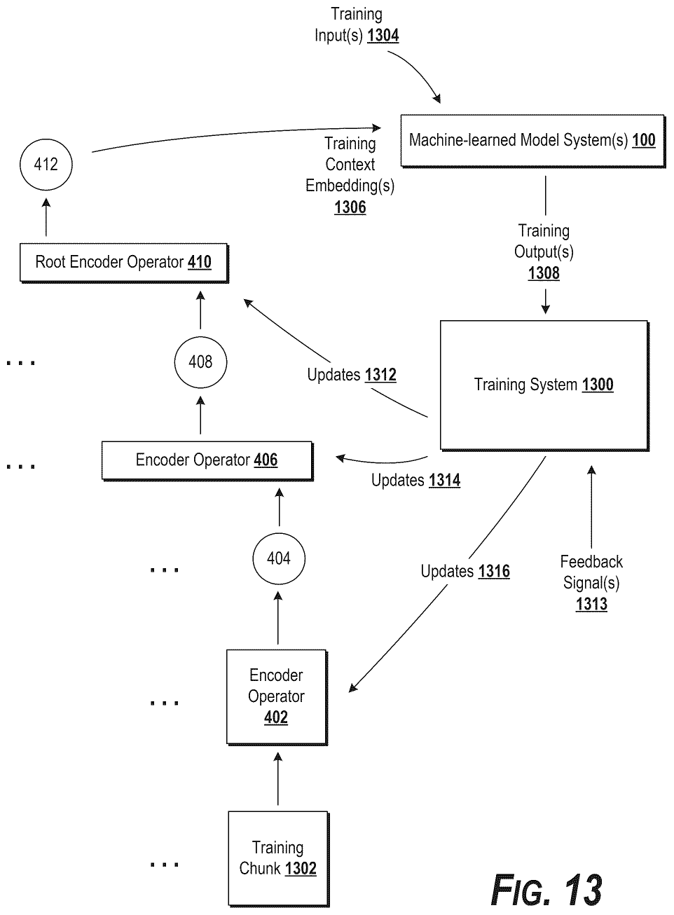

FIG. 11 is a block diagram of aspects of example system for using a context graph according to example aspects of the present disclosure for executing inference using one or more machine-learned model(s). Specifically, context chunking system 1100 can ingest context data 106 and generate chunks 108 to 114.

Context chunking system 1100 can apply a heuristic-based chunking schema. For example, context chunking system 1100 can chunk context data 106 based on length (e.g., a data size, a token count for a given tokenizer, page count, paragraph count, image count, duration or interval, etc.), data attribute (e.g., file type, data format or modality, etc.), demarcated boundaries (e.g., section, chapter, episode, track, etc.), etc.

Context chunking system 1100 can apply a learned chunking schema. Context chunking system 1100 can chunk input data based on predicting segment boundaries (e.g., predicting the boundaries explicitly or predicting the content within the boundaries). For example, context chunking system 1100 can regress a location of a start of chunk (e.g., a position in a list or other ordering of context data, a key in a key-value pairing, etc.).

Context chunking system 1100 can chunk context data based on an available set of encoder operators. For instance, different encoder operators can encode different types or amounts of data. Context chunking system 1100 can process a manifest or other description of available encoder operators and select or implement a chunking schema that is compatible with the available encoder operators.

Context chunking system 1100 can chunk context data 106 based on a provided set of chunking rules or costs. For example, context chunking system 1100 can generate a plurality of candidate chunk sets, evaluate the candidates, and select a set that has a preferred evaluation value (e.g., a lowest cost, a highest score, etc.). Context chunking system 1100 can be trained (e.g., using supervised or unsupervised learning) to generate chunk sets that are expected to optimize an evaluation value.

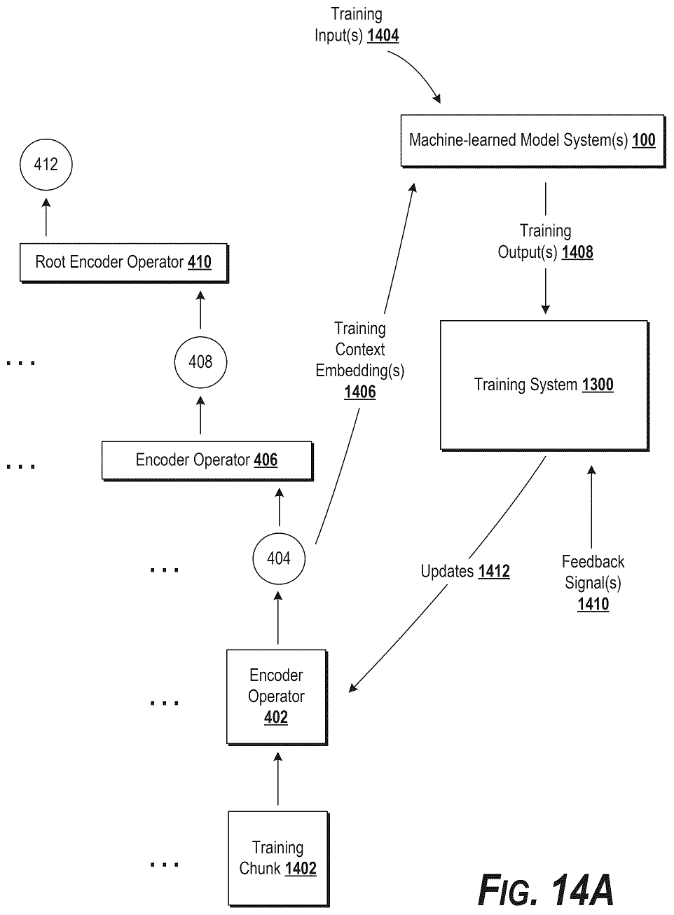

FIG. 12 is a block diagram of aspects of example system for using a context graph according to example aspects of the present disclosure for executing inference using one or more machine-learned model(s). Specifically, content processing system 1200 can use an internal content representation 1202 that can be used to provide context 106.

For instance, a content processing system 1200 can include a media editing application. Content editing application 1200 can include an interactive application that facilitates the editing of text. Content processing application 1200 can include a text editing application or an application that includes a text editing functionality (e.g., a web browser, etc.).

Content processing system 1200 can include a query system configured to query over context data represented in internal content representations 1202. Content processing system 1200 can include a catalog search tool configured to query over a catalogue of content (e.g., books, movies, audio tracks, etc.). Content processing system 1200 can include a data stream query tool configured to execute queries over large volumes of time-varying data (e.g., local sensor data, data from network-connected endpoints, etc.).

Internal content representation(s) 1202 can include a structure representation of content that can be edited using content processing system 1200. Internal content representation(s) 1202 can be or include a rope data structure. Content editing application 1200 can use internal content representation(s) 1202 for internal functionality (e.g., tracking, storing, and reversing edits to text). Internal content representation(s) 1202 can include leaf nodes that are used by context manager 102 to populate chunks 108 to 114. Internal content representation 1202 can be a markup-based representation, such as based on xml or html.

Content processing system 1200 can use machine-learned model system(s) 100 to update the content stored in internal content representations 1202. For example, a text editing application can use machine-learned model system(s) 100 to process input(s) 130 (e.g., based on available context data 106) and generate context data update(s) 140.

For example, a content processing system 1200 can provide an interface for editing long-form content (e.g., text, interleaved text and images, video, etc.). Content processing system 1200 can provide a representation of a current state of the content to context manager 102 to form context data 106 and build a context graph.

Inputs 130 can characterize an instruction, command, or other input from a user to edit a portion of the content. Machine-learned model systems 100 can process inputs 130 in view of one or more encoded representations from context manager 102 to generate updates 140 to the context. These updates can be received by content processing system 1200 and used to update the internal content representation 1202. In turn, context manager 102 can update one or more context chunks of the context graph based on context updates 140.

In this manner, for instance, content processing system 1200 can provide a memory-efficient, interactive interface for engaging machine-learned model system(s) 100 to generate, edit, and query over long contexts. For example, an entire book manuscript can form context data 106. Content processing system 1200 can receive instructions to edit a specific portion of the book. The book can be chunked (e.g., by page; by chapter; etc.) and processed into a context graph. A machine-learned model can process the instructions to edit the specific portion in view of one or more encoded representations. The encoded representation can be a root-level encoded representation that represents the entire book. Content selector 300 can select an encoded representation associated with the specific portion. The machine-learned model can generate content responsive to the instructions, conditioned on the encoded representations. This content can be inserted into the specific portion according to the instructions (e.g., in addition to or in lieu of content already in the portion).

Content processing system 1200 can perform queries over externally-updating data sources. In an example, content processing system 1200 can execute queries over recent publications (e.g., news publications, scientific publications, etc.). Content chunking system 800 can chunk a recent selection of publications according to topic or subject. As new publications are released, updates to the individual chunks can be propagated through the context graph without necessarily invoking a full graph rebuild. In this manner, for instance, a machine-learned model system 100 can maintain a representation of an up-to-date selection of recent publications for executing queries (e.g., for performing research, for grounding its generations, etc.).

For example, this technique can be used as a grounding mechanism for grounding generated content to curated reference material. For instance, some machine-learned models can generate content that represent likely continuations of input content, without being constrained to generate content that is factual. By maintaining a representation of an up-to-date selection of reference materials, and ingesting this representation when executing inference, the likelihood of continuations that conform to the content of the reference materials can be increased.

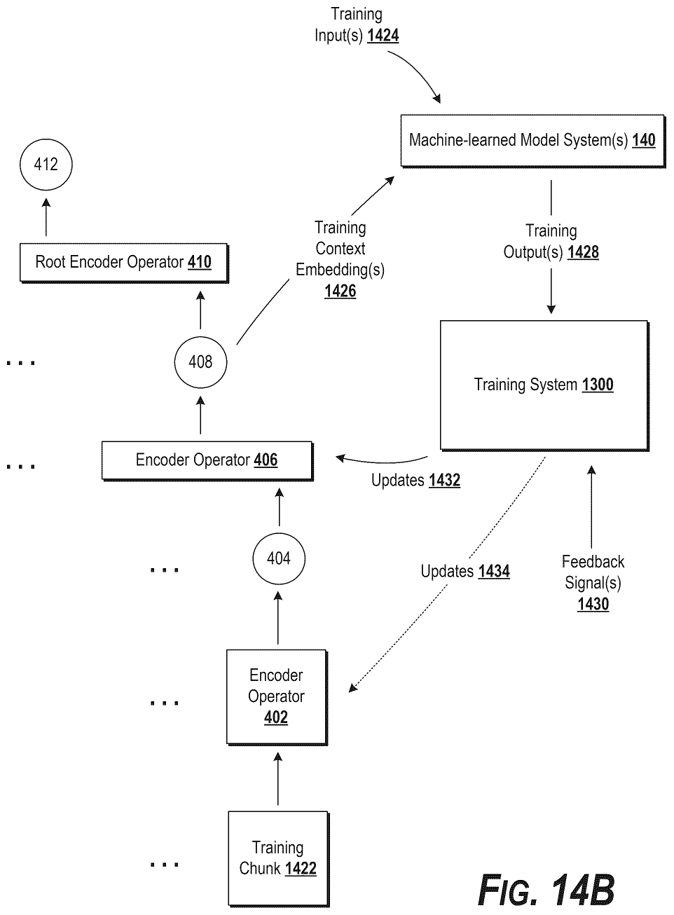

FIG. 13 is a block diagram of aspects of example system for training one or more encoders to obtain a context graph according to example aspects of the present disclosure for executing inference using one or more machine-learned model(s). Specifically, FIG. 13 illustrates an end-to-end training approach.

One or more encoding models used by one or more encoder operators can be trained using training system 1300. FIG. 13 omits depiction of the full context graph for clarity of presentation, and a single training chunk 1302 is shown for illustration purposes. In a forward pass, training chunk 1302 can be encoded by encoder operator 402 into encoded representation 404. Encoder operator 406 can process encoded representation 404 (and one or more other encoded representations) to generate encoded representation 408. Root Encoder operator 410 can process encoded representation 408 (and one or more other encoded representations) to generate root encoded representation 412.

Machine-learned model system(s) 100 can process one or more training inputs 1304 in view of training context embeddings 1306 to generate training outputs 1308. Training system 1300 can evaluate training outputs 1308 in view of feedback signals 1313 (e.g., user feedback, feedback from a reward model, supervised feedback from ground truth data labels, etc.) and generate model updates 1312, 1314, 1316, to update one or more models used by the encoder operators.

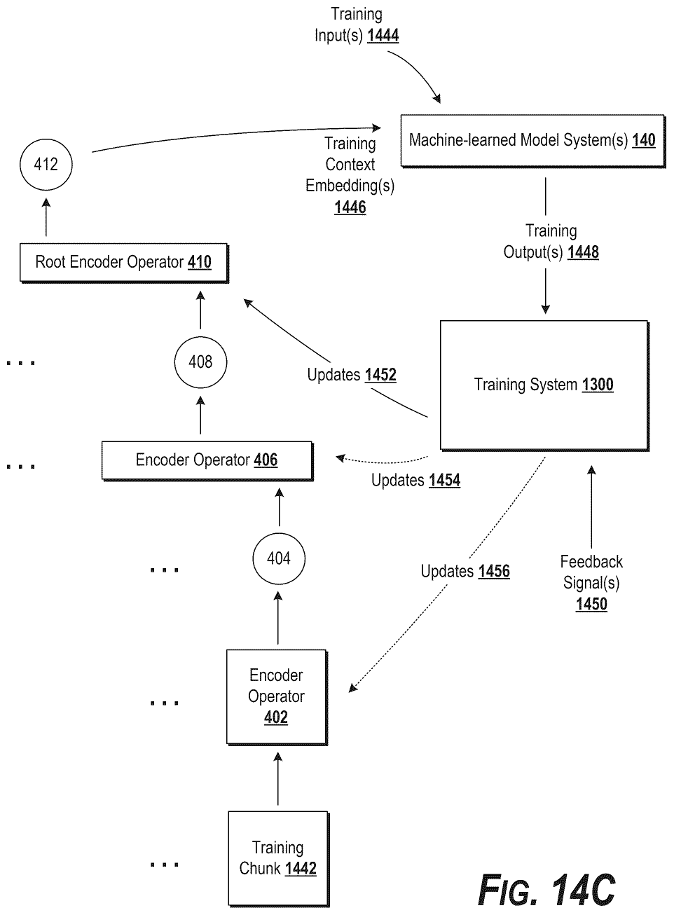

FIGS. 14A, 14B, and 14C are block diagrams of aspects of example system for training one or more encoders to obtain a context graph according to example aspects of the present disclosure for executing inference using one or more machine-learned model(s). Specifically, FIGS. 14A, 14B, and 14C illustrate a staged training approach that trains one or more layers individually to produce encoded representations that are effective for use for input to machine-learned model system(s) 100.

With reference to FIG. 14A, one or more encoding models used by one or more encoder operators can be trained using training system 1300. In a forward pass, training chunk 1402 can be encoded by encoder operator 402 into encoded representation 404. Machine-learned model system(s) 100 can process one or more training inputs 1404 in view of training context embeddings 1406 to generate training outputs 1408. Training system 1300 can evaluate training outputs 1408 in view of feedback signals 1410 (e.g., user feedback, feedback from a reward model, supervised feedback from ground truth data labels, etc.) and generate model updates 1412 to update the one or more models used by encoder operator 402.

Encoder operator 406 can process encoded representation 404 (and one or more other encoded representations) to generate encoded representation 408. Root Encoder operator 410 can process encoded representation 408 (and one or more other encoded representations) to generate root encoded representation 412. This further processing can be used for obtaining updates for other encoders based on training chunk 1402. In an example, both end-to-end training losses and per-layer training losses can be applied together in an aggregate loss.

With reference to FIG. 14B, in a forward pass, training chunk 1422 can be encoded by encoder operator 402 into encoded representation 404. Machine-learned model system(s) 100 can process one or more training inputs 1424 in view of training context embeddings 1426 to generate training outputs 1428. Training system 1300 can evaluate training outputs 1428 in view of feedback signals 1430 (e.g., user feedback, feedback from a reward model, supervised feedback from ground truth data labels, etc.) and generate model updates 1432 to update the one or more models used by encoder operator 406.

Training system 1300 can also generate model updates 1434 to update the one or more models used by encoder operator 402. Model updates 1434 to update the one or more models used by encoder operator 402 can be applied with a decreased training rate to preserve the influence of the primary training iterations shown in FIG. 14A. Models used by encoder operator 402 can be frozen during training of models used by encoder operator 406.

With reference to FIG. 14C, in a forward pass, training chunk 1442 can be encoded by encoder operator 402 into encoded representation 404. Machine-learned model system(s) 100 can process one or more training inputs 1444 in view of training context embeddings 1446 to generate training outputs 1448. Training system 1300 can evaluate training outputs 1448 in view of feedback signals 1450 (e.g., user feedback, feedback from a reward model, supervised feedback from ground truth data labels, etc.) and generate model updates 1452 to update the one or more models used by encoder operator 410.

Training system 1300 can also generate model updates 1454 to update the one or more models used by encoder operator 406. Model updates 1454 to update the one or more models used by encoder operator 406 can be applied with a decreased training rate to preserve the influence of the primary training iterations shown in FIG. 14B. Models used by encoder operator 406 can be frozen during training of models used by encoder operator 410.

Training system 1300 can also generate model updates 1456 to update the one or more models used by encoder operator 402. Model updates 1456 to update the one or more models used by encoder operator 402 can be applied with a decreased training rate to preserve the influence of the primary training iterations shown in FIG. 14A. Models used by encoder operator 402 can be frozen during training of models used by encoder operator 410.

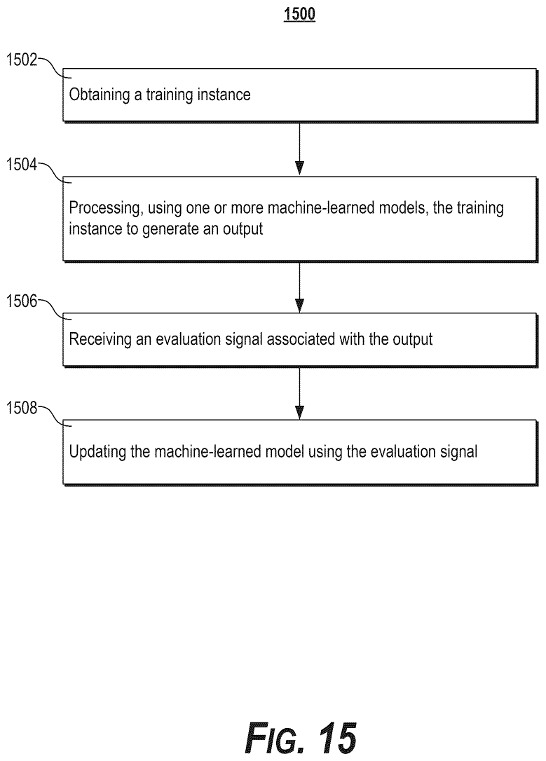

FIG. 15 depicts a flowchart of a method 1500 for training one or more machine-learned models according to aspects of the present disclosure. For instance, an example machine-learned model can include one or more machine-learned models used by an encoder operator, one or more machine-learned models used by machine-learned model system 100, one or more machine-learned models used by context selector 300, one or more machine-learned models used by context chunking system 1100, etc.

One or more portion(s) of example method 1500 can be implemented by a computing system that includes one or more computing devices such as, for example, computing systems described with reference to the other figures. Each respective portion of example method 1500 can be performed by any (or any combination) of one or more computing devices. Moreover, one or more portion(s) of example method 1500 can be implemented on the hardware components of the device(s) described herein, for example, to train one or more systems or models. FIG. 15 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 15 is described with reference to elements/terms described with respect to other systems and figures for exemplary illustrated purposes and is not meant to be limiting. One or more portions of example method 1500 can be performed additionally, or alternatively, by other systems.

At 1502, example method 1500 can include obtaining a training instance. A set of training data can include a plurality of training instances divided between multiple datasets (e.g., a training dataset, a validation dataset, or testing dataset). A training instance can be labeled or unlabeled. Although referred to in example method 1500 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 1504, example method 1500 can include processing, using one or more machine-learned models, the training instance to generate an output. The output can be directly obtained from the one or more machine-learned models or can be a downstream result of a chain of processing operations that includes an output of the one or more machine-learned models. The output can be a final output or an intermediate output (e.g., a logit value associated with a given final output candidate).

At 1506, example method 1500 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 1508, example method 1500 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 1500 can include implementing a number of generalization techniques (e.g., weight decays, dropouts, etc.) to improve the generalization capability of the models being trained.

In some implementations, example method 1500 can be implemented for training a machine-learned model from an initialized state to a fully trained state (e.g., when the model exhibits a desired performance profile, such as based on accuracy, precision, recall, etc.).

In some implementations, example method 1500 can be implemented for particular stages of a training procedure. For instance, in some implementations, example method 1500 can be implemented for pre-training a machine-learned model. Pre-training can include, for instance, large-scale training over potentially noisy data to achieve a broad base of performance levels across a variety of tasks/data types. In some implementations, example method 1500 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

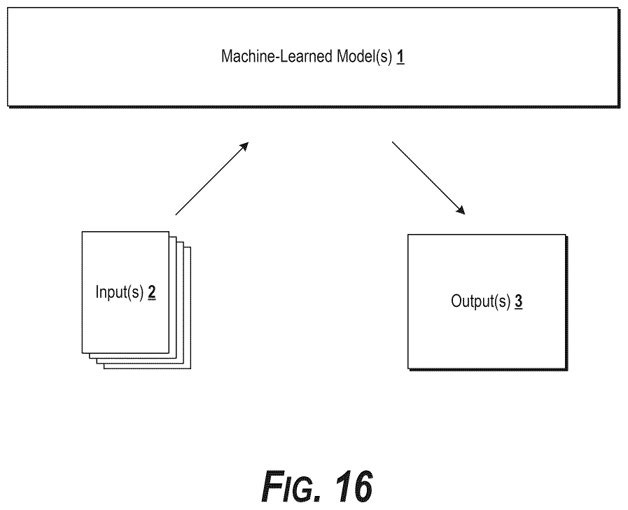

FIG. 16 is a block diagram of an example processing flow for using machine-learned model(s) 1 to process input(s) 2 to generate output(s) 3.

Machine-learned model(s) 1 can be or include any one of or any part of machine-learned models referenced with respect to the preceding figures (e.g., models 106, 402-1, 402-2, etc.). For example, any one or multiple of the following can be a machine-learned model 1: one or more machine-learned models used by an encoder operator, one or more machine-learned models used by machine-learned model system 100, one or more machine-learned models used by context selector 300, one or more machine-learned models used by context chunking system 1100, etc. Features and variations described herein with respect to machine-learned model 1 are to be understood as describing features and variations of any of the machine-learned models described herein. Where this description references machine-learned model 1 it is to be understood that implementations of each of such other models described herein are implicitly referenced and represented thereby.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, ARXIV: 2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

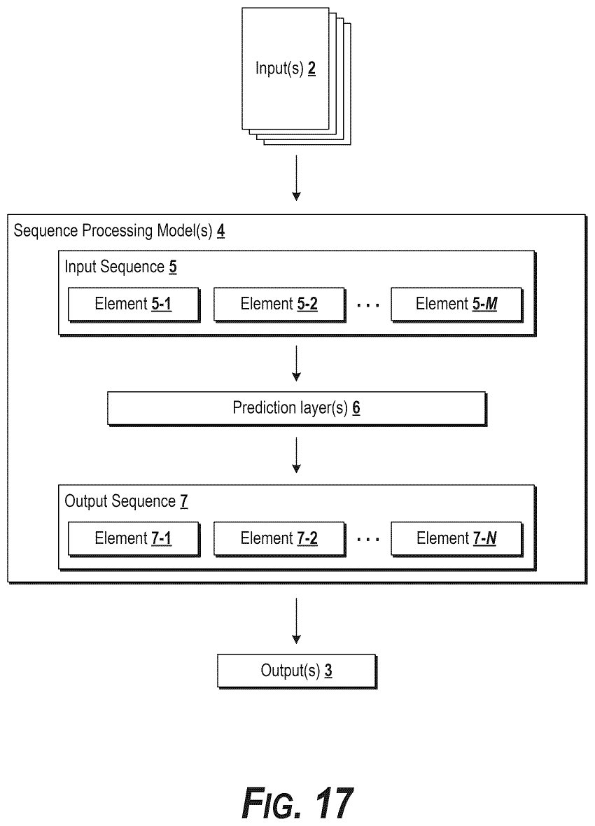

FIG. 17 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV: 2010.11929v2 (Jun. 3, 2021), audio domains, see, e.g., Agostinelli et al., MusicLM: Generating Music From Text, ARXIV: 2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

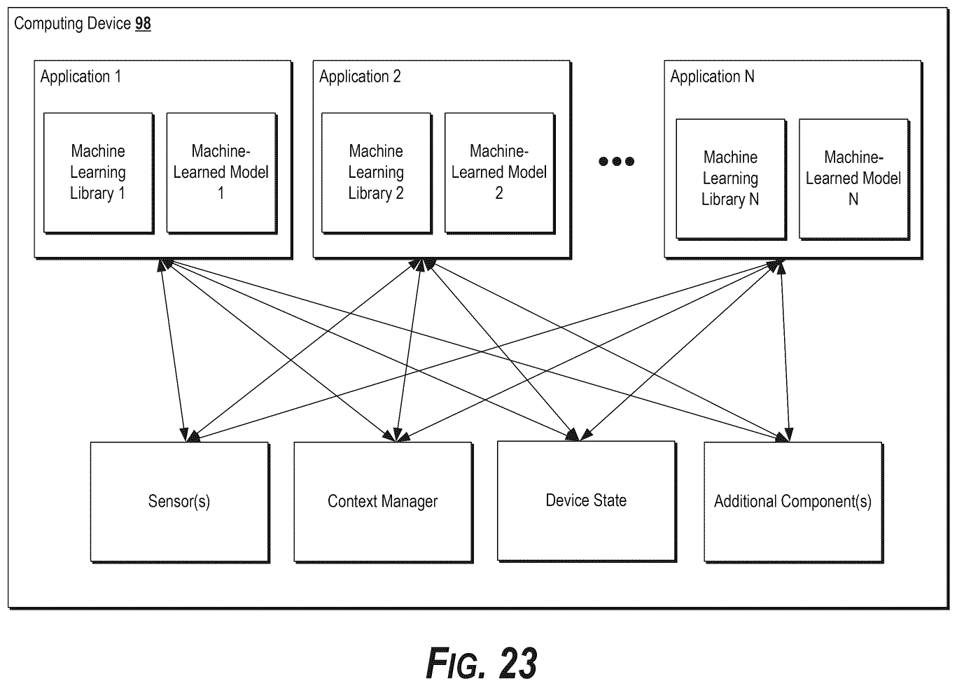

In general, arbitrary data types can be serialized and processed into input sequence 5. It is to be understood that element(s) 5-1, 5-2, . . . , 5-M depicted in FIG. 23 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of _.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV: 1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV: 2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

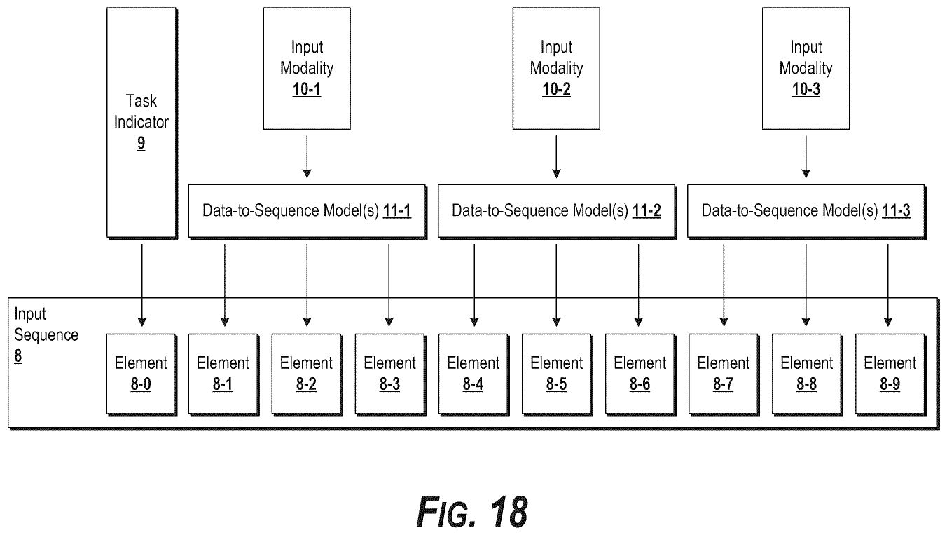

FIG. 18 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be a learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

In an example, an input modality corresponds to a context graph modality. For instance, input modality 10-1 can be a context graph that represents a set of context data 106. Data-to-sequence model(s) 11-1 can include one or more encoding models that generate encoded representations for different positions in the context graph. In an example, data-to-sequence model(s) 11-1 generates one element that corresponds to an encoded representation of a portion or the entirety of the context graph. In an example, data-to-sequence model(s) 11-1 generates multiple elements that respectively correspond to encoded representations of respective portions of the context graph. In an example, data-to-sequence model(s) 11-1 generates multiple elements that respectively corresponds to respective encoded representations that collectively represent a portion or the entirety of the context graph.

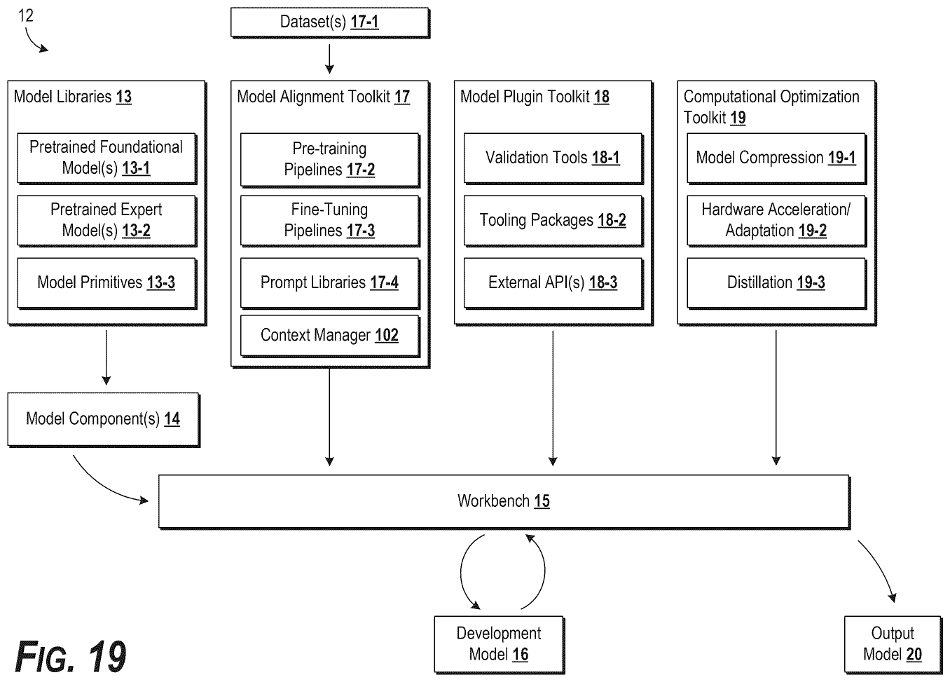

FIG. 19 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output a input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training methods described herein.

Context manager 102 and corresponding libraries can be provided as a tool for inducing alignment of model outputs over long contexts.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instruction that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

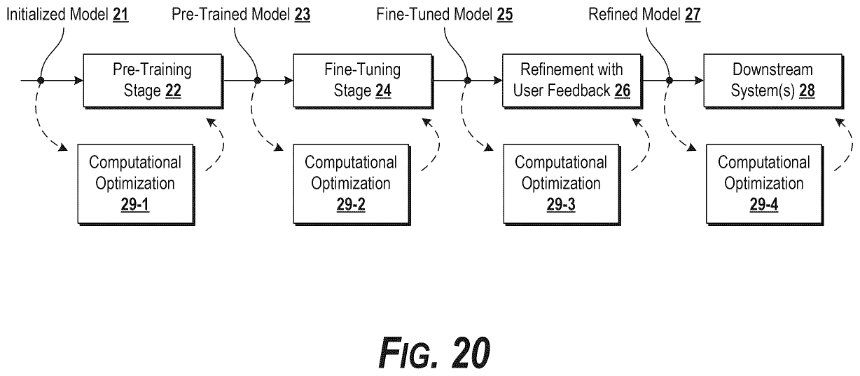

FIG. 20 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 20 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 20 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model as satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

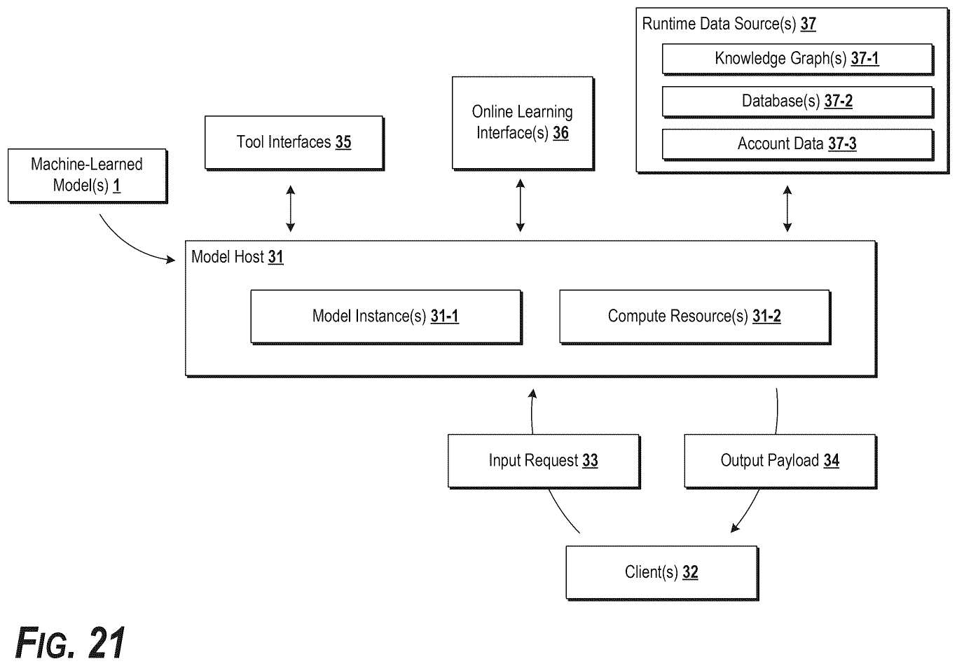

FIG. 21 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored on in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute context manager 102. Model host 31 can receive encoded representations from a context manager 102 executing on client(s) 32. Model host 31 can receive encoded representations from a context manager 102 executing on runtime data source(s) 37. Model host 31 can maintain a cached context graph and receive graph updates from client(s) 32 or runtime data source(s) 37.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may include compressed audio data. In another example, the input includes visual data (e.g. one or more images or videos), the output includes compressed visual data, and the task is a visual data compression task. In another example, the task may include generating an embedding for input data (e.g. input audio or visual data). In some cases, the input includes audio data representing a spoken utterance and the task is a speech recognition task. The output may include a text output which is mapped to the spoken utterance. In some cases, the task includes encrypting or decrypting input data. In some cases, the task includes a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

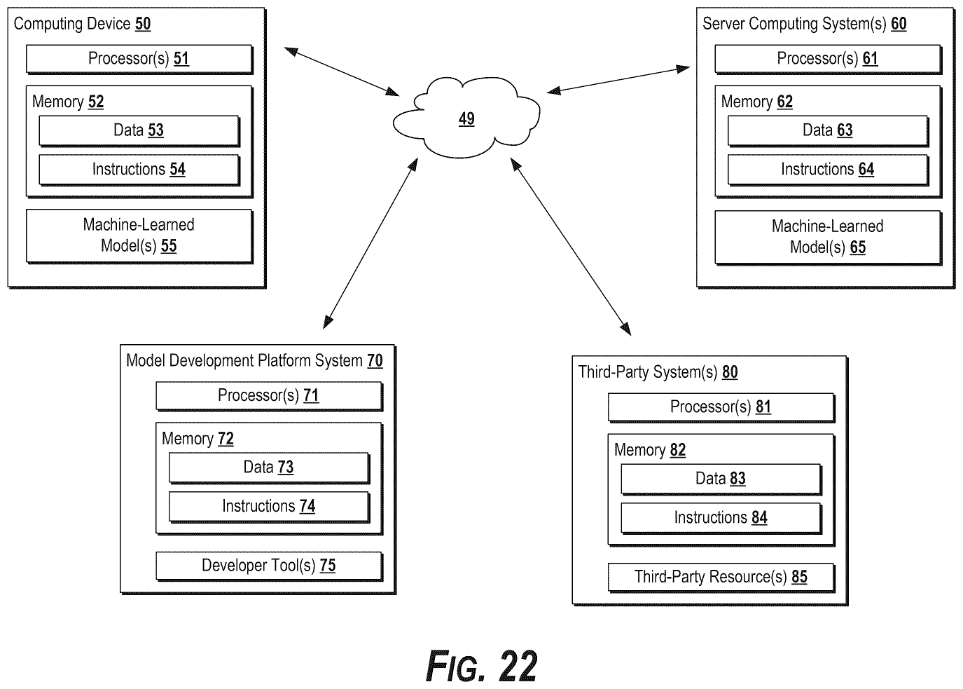

FIG. 22 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 28 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 22 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

FIG. 23 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. Each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

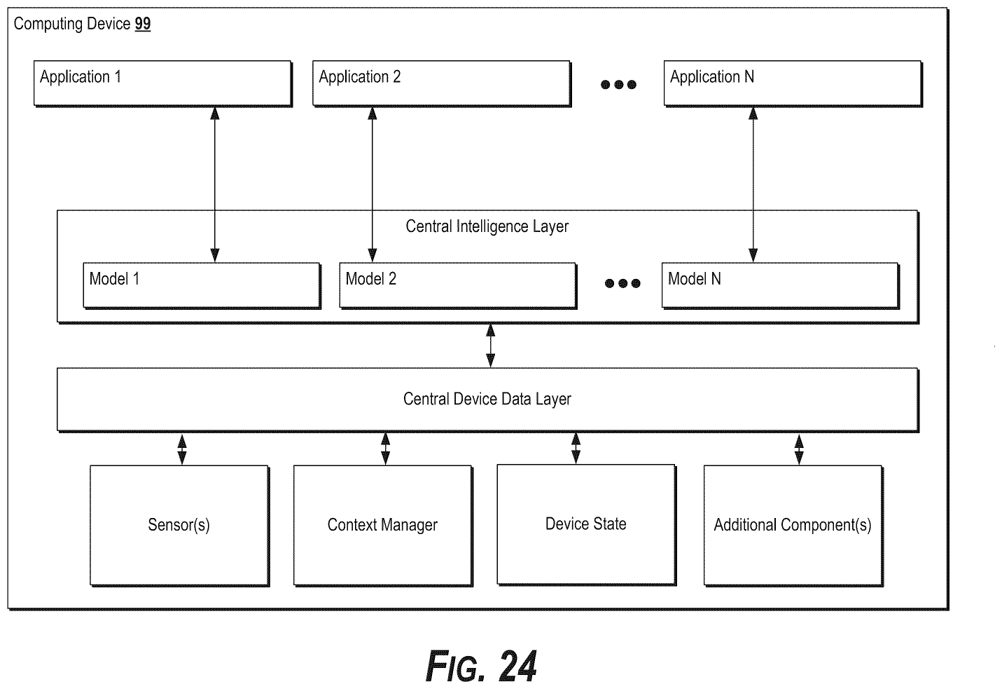

FIG. 24 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. The central device data layer can communicate with a number of other components of the computing device, such as, for example, one or more sensors, a context manager, a device state component, or additional components. In some implementations, the central device data layer can communicate with each device component using an API (e.g., a private API).

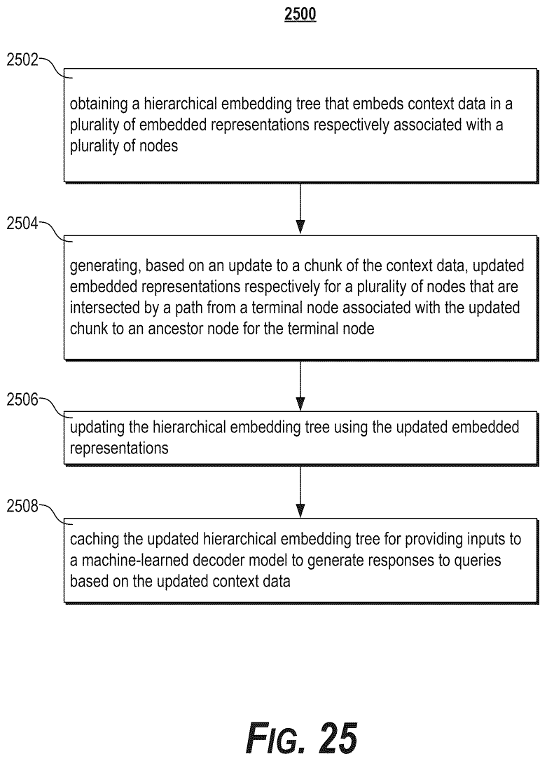

FIG. 25 depicts a flowchart of a method 2500 for obtaining a hierarchical embedding tree, an example context graph according to aspects of the present disclosure. For instance, an example machine-learned model can include one or more machine-learned models used by an encoder operator, one or more machine-learned models used by machine-learned model system 100, one or more machine-learned models used by context selector 300, one or more machine-learned models used by context chunking system 1100, etc.

One or more portion(s) of example method 2500 can be implemented by a computing system that includes one or more computing devices such as, for example, computing systems described with reference to the other figures. Each respective portion of example method 2500 can be performed by any (or any combination) of one or more computing devices. Moreover, one or more portion(s) of example method 2500 can be implemented on the hardware components of the device(s) described herein, for example, to train one or more systems or models. FIG. 25 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 25 is described with reference to elements/terms described with respect to other systems and figures for exemplary illustrated purposes and is not meant to be limiting. One or more portions of example method 2500 can be performed additionally, or alternatively, by other systems.

At 2502, example method 2500 can include obtaining a hierarchical embedding tree that embeds context data in a plurality of embedded representations respectively associated with a plurality of nodes. A hierarchical embedding tree can be, for instance, context graph 104-1.

In some implementations of the example computer-implemented method, each respective embedded representation associated with each respective terminal node of a plurality of terminal nodes of the plurality of nodes is generated based on a respective chunk of the context data. For example, a plurality of terminal nodes can be nodes 116, 118, 120, 122, etc. The encoded representations associated with nodes 116, 118, 120, and 122 can be generated based on chunks 108, 110, 112, and 114, respectively.

In some implementations of the example computer-implemented method, each respective embedded representation associated with each respective non-terminal node of a plurality of non-terminal nodes of the plurality of nodes is generated based on the embedded representations associated with two or more of the plurality of nodes that are child nodes of the respective non-terminal node. In an example, a plurality of non-terminal nodes can include nodes 124, 126, and 128. An encoded representation associated with node 124, for example, can be generated based on the encoded representations associated with its two child nodes (e.g., 116 and 118).

At 2504, example method 2500 can include generating, based on an update to a chunk of the context data, updated embedded representations respectively for a plurality of nodes that are intersected by a path from a terminal node associated with the updated chunk to an ancestor node for the terminal node. For example, based on context data update(s) 140, updated context graph 104-N can be generated by updating encoded representations associated with nodes 120/120′, 126/126′, and 128/128′. Node 120 is associated with the updated chunk 112′. Node 128 is an ancestor node for node 120. Nodes 120/120′, 126/126′, and 128/128′ are intersected by a path from node 120 to node 128.

At 2506, example method 2500 can include updating the hierarchical embedding tree using the updated embedded representations.

At 2508, example method 2500 can include caching the updated hierarchical embedding tree for providing inputs to a machine-learned decoder model to generate responses to queries based on the updated context data. For example, context manager 102 can store encoded representations for each node of the tree in a cache. One or more of the encoded representations can be cached and retrieved for input to machine-learned model system(s) 100.

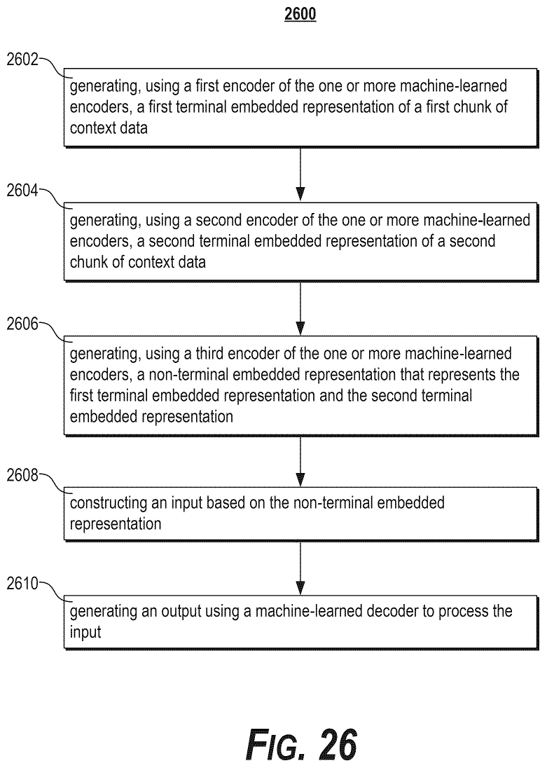

FIG. 26 depicts a flowchart of a method 2600 for executing a machine-learned model to decode encoded representation(s) from encoded representations of an example context graph according to aspects of the present disclosure.

One or more portion(s) of example method 2600 can be implemented by a computing system that includes one or more computing devices such as, for example, computing systems described with reference to the other figures. Each respective portion of example method 2600 can be performed by any (or any combination) of one or more computing devices. Moreover, one or more portion(s) of example method 2600 can be implemented on the hardware components of the device(s) described herein, for example, to train one or more systems or models. FIG. 26 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 26 is described with reference to elements/terms described with respect to other systems and figures for exemplary illustrated purposes and is not meant to be limiting. One or more portions of example method 2600 can be performed additionally, or alternatively, by other systems.

At 2602, example method 2600 can include generating, using a first encoder of one or more machine-learned encoders, a first terminal embedded representation of a first chunk of training context data. For example, encoder operator 402-1 can invoke a machine-learned encoder model to process chunk 400-1 to generate an encoded representation 404-1.

At 2604, example method 2600 can include generating, using a second encoder of the one or more machine-learned encoders, a second terminal embedded representation of a second chunk of training context data. For example, encoder operator 402-2 can invoke a machine-learned encoder model to process chunk 400-2 to generate an encoded representation 404-2.

At 2606, example method 2600 can include generating, using a third encoder of the one or more machine-learned encoders, a non-terminal embedded representation that represents the first terminal embedded representation and the second terminal embedded representation. In one example, encoder operator 406-1 can invoke a machine-learned encoder model to process encoded representation 404-1 and encoded representation 404-2 to generate encoded representation 408-1. Encoded representation 408-1 can represent data encoded by encoded representation 404-1 and encoded representation 404-2. In one example, encoder operator 410 can invoke a machine-learned encoder model to process encoded representations 408-1 and encoded representation 408-2 to generate encoded representation 412. Encoded representation 412 can represent data encoded by encoded representation 404-1 and encoded representation 404-2.

At 2608, example method 2600 can include constructing an input based on the non-terminal embedded representation. For example, constructing an input can include receiving and processing a query to obtain query values for processing along with the non-terminal embedded representation. For instance, FIG. 18 illustrates an example approach for populating an input sequence for a machine-learned sequence processing model.

At 2610, example method 2600 can include generating an output using a machine-learned decoder to process the input. For example, input(s) 130 or input(s) 150 can be processed by machine-learned model system(s) 100 to generate output(s) 134 or 154. Machine-learned model system(s) 100 can use a machine-learned model configured to decode an input containing encoded context representation(s) 132 or 154. The machine-learned decoder can include various different model architectures (e.g., encoder architectures, decoder architectures, etc.).

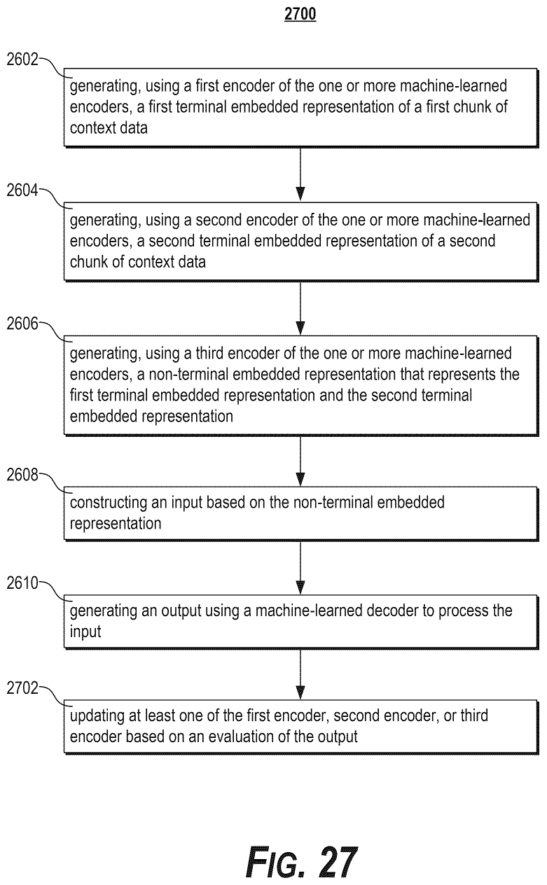

FIG. 27 depicts a flowchart of a method 2700 for training one or more encoding models (e.g., an encoding model used to generate the embedding(s) in example method 2500 or 2600) for generating a hierarchical embedding tree, an example context graph according to aspects of the present disclosure.

One or more portion(s) of example method 2700 can be implemented by a computing system that includes one or more computing devices such as, for example, computing systems described with reference to the other figures. Each respective portion of example method 2700 can be performed by any (or any combination) of one or more computing devices. Moreover, one or more portion(s) of example method 2700 can be implemented on the hardware components of the device(s) described herein, for example, to train one or more systems or models. FIG. 27 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 27 is described with reference to elements/terms described with respect to other systems and figures for exemplary illustrated purposes and is not meant to be limiting. One or more portions of example method 2700 can be performed additionally, or alternatively, by other systems.

At 2702, example method 2700 can include updating at least one of the first encoder, second encoder, or third encoder based on an evaluation of the output. For example, the input can be a training input and the output can be a training output. A training system 1300 can process the training output in view of one or more training signals and generate one or more updates for one or more encoder(s) involved in the computation of the training input.

In some implementations of example method 2500, example method 2600, or example method 2700, the hierarchical embedding tree corresponds to a rope data structure. For instance, a context graph that represents a hierarchy of context embeddings can be implemented using a rope data structure.

In some implementations, example method 2500, example method 2600, or example method 2700 includes, for a respective query, accessing a cached hierarchical embedding tree, the cached hierarchical embedding tree comprising the hierarchical embedding tree or the updated hierarchical embedding tree. For instance, encoded representations of context graph 104-1 can be cached and accessed for future computations using the cached encodings. In some implementations, example method 2500, example method 2600, or example method 2700 includes, for the respective query, constructing a respective input to the machine-learned decoder model based on one or more embedded representations obtained from the cached hierarchical embedding tree. For example, input(s) 130 can be computed using one or more context representation(s) 132 from context graph 104-1, which can be cached. In some implementations, example method 2500, example method 2600, or example method 2700 includes, for the respective query, generating a respective response for the respective query by processing the respective input using the machine-learned decoder model. For example, input(s) 130 or input(s) 150 can be processed by machine-learned model system(s) 100 to generate output(s) 134 or 154. Machine-learned model system(s) 100 can use a machine-learned model configured to decode an input containing encoded context representation(s) 132 or 154. The machine-learned decoder can include various different model architectures (e.g., encoder architectures, decoder architectures, etc.).

In some implementations of example method 2500, example method 2600, or example method 2700, constructing the respective input includes combining the one or more embedded representations with one or more respective query embeddings to form the respective input. Combining the one or more embedded representations with one or more respective query embeddings can include forming a sequence of values representing the respective embeddings. For example, a list of one or more embedding vectors representing tokens of a query can be concatenated with a list of one or more embedding vectors representing the embedded representations obtained from the context graph.

In some implementations of example method 2500, example method 2600, or example method 2700, the one or more embedded representations comprise a root embedding associated with a root of the cached embedding tree. For example, context representation(s) 132 or 152 can include an encoding associated with node 128/128′.

In some implementations of example method 2500, example method 2600, or example method 2700, constructing the respective input includes obtaining a sequence of component embeddings based on the one or more embedded representations. For example, encoded representation 128 (or another encoded representation) can include a sequence of component embeddings (e.g., corresponding to “tokens” for representing encoded information; codeworks from a codebook; etc.). Encoded representation 128 can be a product-quantized value that includes component vectors. In some implementations of example method 2500, example method 2600, or example method 2700, constructing the respective input includes combining the sequence of component embeddings (e.g., a sequence of embedding vectors) with a sequence of respective query embeddings to form an input sequence for the respective input.

In some implementations of example method 2500, example method 2600, or example method 2700, a dimensionality of the component embeddings match a dimensionality of the respective query embeddings (e.g., to facilitate compatibility for performing matrix-based computations).

In some implementations of example method 2500, example method 2600, or example method 2700, the machine-learned decoder model is a sequence processing model (e.g., model 4) that performs self-attention over the input sequence to generate an output sequence.

In some implementations of example method 2500, example method 2600, or example method 2700, the cached hierarchical embedding tree stores a respective sequence of component embeddings for each respective node. In some implementations of example method 2500, example method 2600, or example method 2700, the cached hierarchical embedding tree stores a respective sequence of component embeddings for the root node. In some implementations of example method 2500, example method 2600, or example method 2700, obtaining the sequence of component embeddings includes processing the one or more embedded representations using a machine-learned adapter model configured to receive one or more input embeddings.

In some implementations, example method 2500, example method 2600, or example method 2700 includes obtaining the update to the chunk of the context data (e.g., context data update(s) 140).

In some implementations of example method 2500, example method 2600, or example method 2700, obtaining the update to the chunk of the context data includes constructing a first input to the machine-learned decoder model based on one or more embedded representations obtained from the hierarchical embedding tree before the hierarchical embedding tree is updated. For instance, output(s) 134 can be used to obtain context data update(s) 140.

In some implementations of example method 2500, example method 2600, or example method 2700, obtaining the update to the chunk of the context data includes generating a first response for a first query by processing the first input using the machine-learned decoder model. In some implementations of example method 2500, example method 2600, or example method 2700, obtaining the update to the chunk of the context data includes updating the chunk with updated data that is based on the first response. In some implementations of example method 2500, example method 2600, or example method 2700, the first query includes an instruction to edit a portion of the context data. For instance, a content processing application 900 can receive an instruction to edit a chapter of a book, a scene from a video, etc.

In some implementations, example method 2500, example method 2600, or example method 2700 includes generating a first embedded representation for a first node of the hierarchical embedding tree using a first machine-learned encoder. In some implementations, example method 2500, example method 2600, or example method 2700 includes generating a second embedded representation for a second node of the hierarchical embedding tree using a second machine-learned encoder. In some implementations of example method 2500, example method 2600, or example method 2700, the first machine-learned encoder is different from the second machine-learned encoder. For example, FIG. 4 illustrates generating encoded representations using encoder operators. An encoder operator can include a function call, API call, or other executable instruction set that initiates an encoding operation, performed by a machine-learned encoder, on an input data item to output an encoded representation thereof. Multiple different encoder operators can use the same machine-learned encoder with different input(s). Different encoder operators can use different machine-learned encoders.

In some implementations of example method 2500, example method 2600, or example method 2700, the first node corresponds to a chunk of the context data containing data of a first data modality, and wherein the first machine-learned encoder is configured to process the first data modality. In some implementations of example method 2500, example method 2600, or example method 2700, the second node corresponds to a chunk of the context data containing data of a second data modality, and wherein the second machine-learned encoder is configured to process the second data modality.

In some implementations of example method 2500, example method 2600, or example method 2700, the first node is the terminal node associated with the updated chunk, and wherein the first embedded representation has a first precision. In some implementations of example method 2500, example method 2600, or example method 2700, the second node is the ancestor node, and wherein the second embedded representation has a second precision greater than the first precision (e.g., increased dimensionality of embeddings, higher quantity of embeddings, increased bit depth, larger codebook, etc.). In an example, encodings used for higher-level nodes (e.g., nodes that represent a larger range of context data) can be more expressive (e.g., increased dimensionality of embeddings, higher quantity of embeddings, increased bit depth, larger codebook, etc.) than lower-level nodes (e.g., nodes that represent a smaller range of context data).

In some implementations of example method 2500, example method 2600, or example method 2700, the second precision being greater than the first precision includes a dimensionality of the second embedded representation is higher than a dimensionality of the first embedded representation. In some implementations of example method 2500, example method 2600, or example method 2700, the second precision being greater than the first precision includes a bit depth used for the second embedding is higher than a bit depth used for the first embedding.

In some implementations of example method 2500, example method 2600, or example method 2700, updating the hierarchical embedding tree using the updated embedded representations includes inserting, in the hierarchical embedding tree, a non-destructive update comprising the updated embedded representations and versioning data associated with the updated embedded representations. For example, a hierarchical data structure can store node values and version numbers for the node values. In some implementations of example method 2500, example method 2600, or example method 2700, the hierarchical embedding tree is configured to facilitate retrieval of a cached embedded representation based on versioning data associated with the cached embedded representation. In this manner, for instance, context data changes can be “rolled back” (e.g., an “undo” operation) for further use.

In some implementations, example method 2500, example method 2600, or example method 2700 includes accessing a context data tree generated by a context data processing application, wherein the context data tree includes the plurality of nodes, and wherein the cached hierarchical embedding tree inherits the plurality of nodes from the context data tree. For example, a context data tree can be an internal context data representation 902 of a content processing application 900.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method comprising:
obtaining a hierarchical embedding tree that embeds context data in a plurality of embedded representations respectively associated with a plurality of nodes, wherein:
each respective embedded representation associated with each respective terminal node of a plurality of terminal nodes of the plurality of nodes is generated based on a respective chunk of the context data, and
each respective embedded representation associated with each respective non-terminal node of a plurality of non-terminal nodes of the plurality of nodes is generated based on the embedded representations associated with two or more of the plurality of nodes that are child nodes of the respective non-terminal node;
generating, based on an update to a chunk of the context data, updated embedded representations respectively for a plurality of nodes that are intersected by a path from a terminal node associated with the updated chunk to an ancestor node for the terminal node;
updating the hierarchical embedding tree using the updated embedded representations; and
caching the updated hierarchical embedding tree for providing inputs to a machine-learned decoder model to generate responses to queries based on the updated context data.

2. The computer-implemented method of claim 1, wherein the hierarchical embedding tree corresponds to a rope data structure.

3. The computer-implemented method of claim 1, comprising, for a respective query:
accessing a cached hierarchical embedding tree, the cached hierarchical embedding tree comprising the hierarchical embedding tree or the updated hierarchical embedding tree;
constructing a respective input to the machine-learned decoder model based on one or more embedded representations obtained from the cached hierarchical embedding tree; and
generating a respective response for the respective query by processing the respective input using the machine-learned decoder model.

4. The computer-implemented method of claim 3, wherein constructing the respective input comprises:
combining the one or more embedded representations with one or more respective query embeddings to form the respective input.

5. The computer-implemented method of claim 3, wherein the one or more embedded representations comprise a root embedding associated with a root of the cached embedding tree.

6. The computer-implemented method of claim 3, wherein constructing the respective input comprises:
obtaining a sequence of component embeddings based on the one or more embedded representations; and
combining the sequence of component embeddings with a sequence of respective query embeddings to form an input sequence for the respective input.

7. The computer-implemented method of claim 6, wherein a dimensionality of the component embeddings match a dimensionality of the respective query embeddings.

8. The computer-implemented method of claim 7, wherein the machine-learned decoder model is a sequence processing model that performs self-attention over the input sequence to generate an output sequence.

9. The computer-implemented method of claim 6, wherein:
the cached hierarchical embedding tree stores a respective sequence of component embeddings for each respective node;
the cached hierarchical embedding tree stores a respective sequence of component embeddings for the root node; or
obtaining the sequence of component embeddings comprises processing the one or more embedded representations using a machine-learned adapter model configured to receive one or more input embeddings.

10. The computer-implemented method of claim 1, comprising:
obtaining the update to the chunk of the context data, wherein obtaining the update to the chunk of the context data comprises:
constructing a first input to the machine-learned decoder model based on one or more embedded representations obtained from the hierarchical embedding tree before the hierarchical embedding tree is updated;
generating a first response for a first query by processing the first input using the machine-learned decoder model; and
updating the chunk with updated data that is based on the first response.

11. The computer-implemented method of claim 10, wherein the first query comprises an instruction to edit a portion of the context data.

12. The computer-implemented method of claim 1, comprising:
generating a first embedded representation for a first node of the hierarchical embedding tree using a first machine-learned encoder; and
generating a second embedded representation for a second node of the hierarchical embedding tree using a second machine-learned encoder.

13. The computer-implemented method of claim 12, wherein the first machine-learned encoder is different from the second machine-learned encoder.

14. The computer-implemented method of claim 13, wherein:
the first node corresponds to a chunk of the context data containing data of a first data modality, and wherein the first machine-learned encoder is configured to process the first data modality; and
the second node corresponds to a chunk of the context data containing data of a second data modality, and wherein the second machine-learned encoder is configured to process the second data modality.

15. The computer-implemented method of claim 12, wherein:
the first node is the terminal node associated with the updated chunk, and wherein the first embedded representation has a first precision; and
the second node is the ancestor node, and wherein the second embedded representation has a second precision greater than the first precision.

16. The computer-implemented method of claim 15, wherein the second precision being greater than the first precision comprises:
a dimensionality of the second embedded representation is higher than a dimensionality of the first embedded representation; or
a bit depth used for the second embedding is higher than a bit depth used for the first embedding.

17. The computer-implemented method of claim 1, wherein:
updating the hierarchical embedding tree using the updated embedded representations comprises:
inserting, in the hierarchical embedding tree, a non-destructive update comprising the updated embedded representations and versioning data associated with the updated embedded representations; and
the hierarchical embedding tree is configured to facilitate retrieval of a cached embedded representation based on versioning data associated with the cached embedded representation.

18. The computer-implemented method of claim 1, comprising:
accessing a context data tree generated by a context data processing application, wherein the context data tree comprises the plurality of nodes, and wherein the cached hierarchical embedding tree inherits the plurality of nodes from the context data tree.

19. A computer-implemented method for training one or more machine-learned encoders for generating a hierarchical embedding tree, comprising:
generating, using a first encoder of the one or more machine-learned encoders, a first terminal embedded representation of a first chunk of training context data;
generating, using a second encoder of the one or more machine-learned encoders, a second terminal embedded representation of a second chunk of training context data;
generating, using a third encoder of the one or more machine-learned encoders, a non-terminal embedded representation that represents the first terminal embedded representation and the second terminal embedded representation;
constructing a training input based on the non-terminal embedded representation;
generating a training output using a machine-learned decoder to process the training input; and
updating at least one of the first encoder, second encoder, or third encoder based on an evaluation of the training output.

20. A computing system comprising:
one or more processors; and
one or more non-transitory computer-readable media storing:
a cached hierarchical embedding tree that embeds context data in a plurality of embedded representations respectively associated with a plurality of nodes, wherein:
each respective embedded representation associated with each respective terminal node of the cached hierarchical embedding tree is generated based on a respective chunk of the context data, and
each respective embedded representation associated with each respective non-terminal node of the cached hierarchical embedding tree is generated based on the embedded representations associated with two or more child nodes of the respective non-terminal node; and
instructions that are executable by the one or more processors to cause the computing system to perform operations comprising:
generating, based on an update to a chunk of the context data, updated embedded representations respectively for a plurality of nodes of the cached hierarchical embedding tree that are intersected by a path from a terminal node associated with the updated chunk to an ancestor node for the terminal node;
updating the cached hierarchical embedding tree using the updated embedded representations; and
providing an input based on the cached hierarchical embedding tree to a machine-learned decoder model to generate a response to a query associated with the updated context data.
